(19) United States
(12) Patent Application Publication
(10) Pub. No.: US 2012/0311237 A1
(43) Pub. Date: Dec. 6, 2012

(54) STORAGE DEVICE, STORAGE SYSTEM AND METHOD OF VIRTUALIZING A STORAGE DEVICE

(76) Inventor: Young-Jin PARK, Incheon (KR)

(21) Appl. No.: 13/429,329

(22) Filed: Mar. 24, 2012

Related U.S. Application Data
(60) Provisional application No. 61/513,014, filed on Jul. 29, 2011.

(30) Foreign Application Priority Data
May 30, 2011 (KR) 10-2011-0051178

(51) Int. Cl. G06F 12/00

(52) U.S. Cl. 711/103; 711/E12.008

(57) ABSTRACT

A storage device includes a storage media including a one or more nonvolatile memories and a controller. The controller controls the nonvolatile memories, provides a virtual storage to an external host via at least one of the nonvolatile memories and erases a memory block of corresponding nonvolatile memory including data at physical addresses corresponding to data in the virtual storage.

### CROSS-REFERENCE TO RELATED APPLICATION(S)

This U.S. non-provisional application claims benefit of priority under 35 USC §119 to U.S. Provisional Application No. 61/513,014 filed on Jul. 29, 2011, the contents of which are herein incorporated by reference in its entirety. This U.S. non-provisional application also claims benefit of priority under 35 USC §119 to Korean Patent Application No. 10-2011-0051178 filed on May 30, 2011 in the Korean Intellectual Property Office (KIPO), the contents of which are herein incorporated by reference in its entirety.

### BACKGROUND

Modern electronic devices commonly use large amounts of memory. For instance, devices such as personal computers, laptops, smart phones, digital video recorders, and others, often come equipped with several gigabytes or even terabytes of memory. Moreover, auxiliary memory devices, such as portable flash cards and compact flash cards, can be used to supplement the data stores of many devices.

These large amounts of memory can take a variety of forms, including various forms of nonvolatile and volatile memory. Hard disk drives (HDDs), for instance, are one common way of providing large amounts of memory due to its relatively high integration density and relatively low cost. Similarly, dynamic random access memory (DRAM) and static random access memory (SRAM) are also common due to their relatively high speed and low cost. Unfortunately, all of these types of memories have some significant drawbacks. For instance, HDDs have numerous moving parts and are relatively susceptible to defects from mechanical shock. Meanwhile, DRAMs and SRAMs are both volatile forms of memory, so they do not store data when disconnected from power.

Some increasingly common alternatives to the above types of memory are nonvolatile memories such as flash memory. Flash memories have a number of attractive properties, including relatively high integration density, decreasing cost, ability to withstand physical shock, nonvolatile data storage, and others. Because of these and other properties, flash memories have already been adopted for use in a wide variety of electronic devices, ranging from portable devices to home electronics and others.

### SUMMARY

Example embodiments relate to data storage, and more particularly to a storage device using a flash memory, a storage system and a method of virtualizing a storage device.

In one embodiment, an exemplary method of operating a solid state drive including a controller and a nonvolatile memory comprises the steps of: creating a virtual memory drive with the nonvolatile memory, the virtual memory drive comprising multiple physical addresses; storing a computer file in the virtual memory drive at a first set of locations corresponding to a first set of the multiple physical addresses; associating the first set of the multiple physical addresses to a single logical address in a table; moving the computer file in the virtual memory drive to a second set of locations corresponding to a second set of the multiple physical addresses; and associating the second set of the multiple physical addresses to the single logical address in the table.

In one embodiment, an exemplary storage device comprises a plurality of nonvolatile memories; a controller configured to control the nonvolatile memories, configured to provide a virtual memory to an external host utilizing at least a first nonvolatile memory and configured to erase a first memory block of the first nonvolatile memory including first data stored in the virtual memory in response to a delete request of the first data stored in the virtual memory. The controller of the exemplary storage device is configured to erase the first memory block of the first nonvolatile memory by generating an internal trim command in response to the delete request of the first data stored in the virtual memory.

In one embodiment, a method of operating a solid state drive including a controller and a nonvolatile memory comprises the steps of: creating a virtual memory drive with the nonvolatile memory, the virtual memory drive having multiple logical addresses corresponding to multiple physical addresses; storing a computer file in the virtual memory drive at a first set of the multiple physical addresses; moving the computer file in the virtual memory drive to a second set of the multiple physical addresses; and performing a garbage collection operation of the nonvolatile memory associated at least a portion of the first set of multiple physical addresses corresponding to those parts of the computer file which were moved, wherein storing the computer file in the virtual memory drive comprises storing the computer file in a first sequence of parts; and generating an internal TRIM command by the controller for the nonvolatile memory associated at least a portion of the first set of multiple physical addresses corresponding to those parts of the computer file which were moved, wherein moving the computer file in the virtual memory drive comprises rearranging the first sequence of parts of the computer file to store the computer file in a second sequence of parts, the second sequence being different from the first sequence.

### BRIEF DESCRIPTION OF THE DRAWINGS

The above and other aspects and features of the disclosure will become apparent by describing in detail exemplary embodiments thereof with reference to the attached drawings, in which:

FIG. 1 is a block diagram illustrating a storage system including a storage device according to some example embodiments.

FIG. 2 is a block diagram illustrating an example of the storage device of FIG. 1 according to some embodiments.

FIG. 3 illustrates an example of the firmware 300 stored in the ROM in FIG. 2.

FIG. 4 is a block diagram illustrating one of the flash memories included in the storage media in FIG. 2 according to some example embodiments.

FIG. 5 is a block diagram illustrating an example of the memory cell array in FIG. 4.

FIGS. 6 and 7 is a flow chart illustrating a method of virtualizing a storage device according to some example embodiments.

FIG. 8 is a diagram for explaining garbage collection performed in a flash memory device according to some example embodiments.

FIG. 9 is a diagram illustrating a page in FIG. 8.

FIGS. 10 and 11 are diagrams for explaining virtual memory (or virtual disk) according to some example embodiments.

FIG. 12 is a diagram illustrating a virtualization file table according to some example embodiments.

FIG. 13 illustrates that the storage device provides the virtual storage in the storage system in FIG. 1 according to some example embodiments.

FIG. 14 illustrates a virtualization file table according to some example embodiments.

FIG. 15 illustrates virtual trim operation performed on the data in the virtual storage in the storage system in FIG. 1 according to some example embodiments.

FIG. 16 is a flowchart showing an exemplary operation of a virtual trim VTRIM command in a virtual storage VS with the VFT 360 of FIG. 14.

FIG. 17 is a timing diagram for illustrating operation of the storage device according to some example embodiments.

FIGS. 18A and 18B illustrates that the virtual trim command is performed in the flash memory according to some example embodiments.

FIG. 19 is a block diagram illustrating a computer system that implements virtualization according to some example embodiments.

FIG. 20 is a flow chart illustrating a method of writing data in a virtual storage according to some example embodiments.

FIG. 21 is a flow chart illustrating a method of deleting data in a virtual storage according to some example embodiments.

FIG. 22 is a block diagram illustrating an electronic device using a storage device according to some example embodiments.

FIG. 23 is a block diagram illustrating an example of a storage server using a storage device according to some example embodiments.

FIG. 24 is a block diagram illustrating an example of a server system using a storage device according to some example embodiments.

FIG. 25 is a block diagram illustrating an example of a system for providing a cloud computing service according to some example embodiments.

FIG. 26 is a block diagram illustrating an example of the management server in FIG. 25 according to some example embodiments.

### DETAILED DESCRIPTION OF THE EMBODIMENTS

Various example embodiments will be described more fully hereinafter with reference to the accompanying drawings, in which some example embodiments are shown. The invention may, however, be embodied in many different forms and should not be construed as limited to the example embodiments set forth herein. That is, the exemplary embodiments are just that—examples—many implementations and variations are possible that do not require the various details herein. It should also be emphasized that the disclosure provides details of alternative examples, but such listing of alternatives is not exhaustive. Furthermore, any consistency of detail between various examples should not be interpreted as requiring such detail—it is impracticable to list every possible variation for every feature described herein. The language of the claims should be referenced in determining the requirements of the invention. In the drawings, the sizes and relative sizes of layers and regions may be exaggerated for clarity. Like numerals refer to like elements throughout.

It will be understood that, although the terms first, second, third etc. may be used herein to describe various elements, components, regions, layers, and/or sections, these elements, components, regions, layers, and/or sections should not be limited by these terms. Unless indicated otherwise, these terms are used to distinguish one element, component, region, layer, and/or section from another element, component, region, layer, and/or section. Thus, a first element, component, region, layer, and/or section discussed below could be termed a second element, component, region, layer, and/or section, and, similarly, a second element, component, region, layer, and/or section could be termed a first element, component, region, layer, and/or section without departing from the teachings of the disclosure. As used herein, the term “and/or” includes any and all combinations of one or more of the associated listed items and may be abbreviated “/”.

It will be understood that when an element or layer is referred to as being “connected” or “coupled” to another element or layer, it can be directly connected or coupled to the other element or layer or intervening elements or layers may be present. In contrast, when an element or layer is referred to as being “directly connected” or “directly coupled” to another element or layer, there are no intervening elements present.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present inventive concept.

The terminology used herein is for the purpose of describing particular example embodiments only and is not intended to be limiting of the example embodiments. As used herein, the singular forms “a,” “an” and “the” should not exclude the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

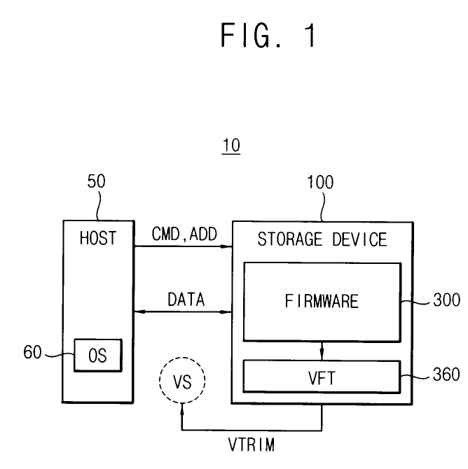

FIG. 1 is a block diagram illustrating a storage system including a storage device according to some example embodiments.

Referring to FIG. 1, a storage system 10 includes a host 50 and a storage device 100 connected to the host 50.

The storage device 100 may include one or more nonvolatile memories. The nonvolatile memories may include one or more of a NAND Flash Memory, a vertical NAND, a NOR Flash Memory, a Resistive Random Access Memory (RRAM), a Phase-Change Memory (PRAM), a Magnetroresistive Random Access Memory (MRAIVI), a Ferroelectric Random Access Memory (FRAM) and/or a Spin Transfer Torque Random Access Memory (STT-RAM). In some embodiments, the nonvolatile memories may be implemented in a three-dimensional array structure. In some embodiments, the nonvolatile memories may include floating gate flash memories and/or charge-trapped flash memories.

In some embodiments, the storage device 100 may be a solid state drive (SSD).

The storage device 100 may include a firmware 300 for providing a virtual storage VS to the host 50. For example, in response to a virtualization request, the firmware 300 may create a virtual storage VS in the storage device 100. The virtual storage VS may also be referred to as a virtual drive. The virtual storage may include multiple virtual files with virtual addresses corresponding to multiple physical addresses in the storage device 100. The virtual addresses may also be referred to as logical addresses. The virtual addresses may be the address used by a virtual management module to access or identify the data stored in the virtual storage.

In some embodiments, the firmware 300 may generate a virtualization file table (VFT) 360 for associating data in the virtual storage VS with corresponding physical addresses of physical areas of the storage device 100 in which the virtual storage VS is stored. In some embodiments, the firmware 300 may generate a virtual trim VTRIM command in response to a request to delete data in the virtual storage (when a delete request to the data in the virtual storage VS occurs). The VTRIM command may cause the erasure of the data of the virtual storage to be deleted via erasure of one or more memory blocks of a nonvolatile memory device, including the data at the physical addresses corresponding to the relevant virtual addresses of the virtual storage. The virtual trim VTRIM command may be a command generated internal to the storage device 100, generated by the firmware 300 and performed on storage media 200. The virtual trim VTRIM command may also be referred to as an internal TRIM command. Details of an exemplary virtual trim VTRIM command and an exemplary virtualization file table VFT will be described below further, with reference, for example, to FIGS. 14-18B.

The host 50 may store data DATA into the storage device 100 or read data DATA from the storage device 100. The host 50 may transfer commands CMD and addresses ADD to the storage device 100. In some embodiments, the host 50 may be one of a personal computer, a digital camera, a PDA, a mobile phone, a smart television, and a server. The host 50 may include an operating system (OS) 60 that runs on the host 50. The host 50 and the storage device 100 may be connected to each other through one of various interface protocols such as USB (Universal Serial Bus) protocol, MMC (multimedia card) protocol, PCI (peripheral component interconnection) protocol, PCI-E (PCI-express) protocol, ATA (Advanced Technology Attachment) protocol, Serial-ATA (SATA) protocol, ESATA (External SATA) protocol, Parallel-ATA protocol, SCSI (small computer small interface) protocol, ESDI (enhanced small disk interface) protocol and IDE (Integrated Drive Electronics) protocol.

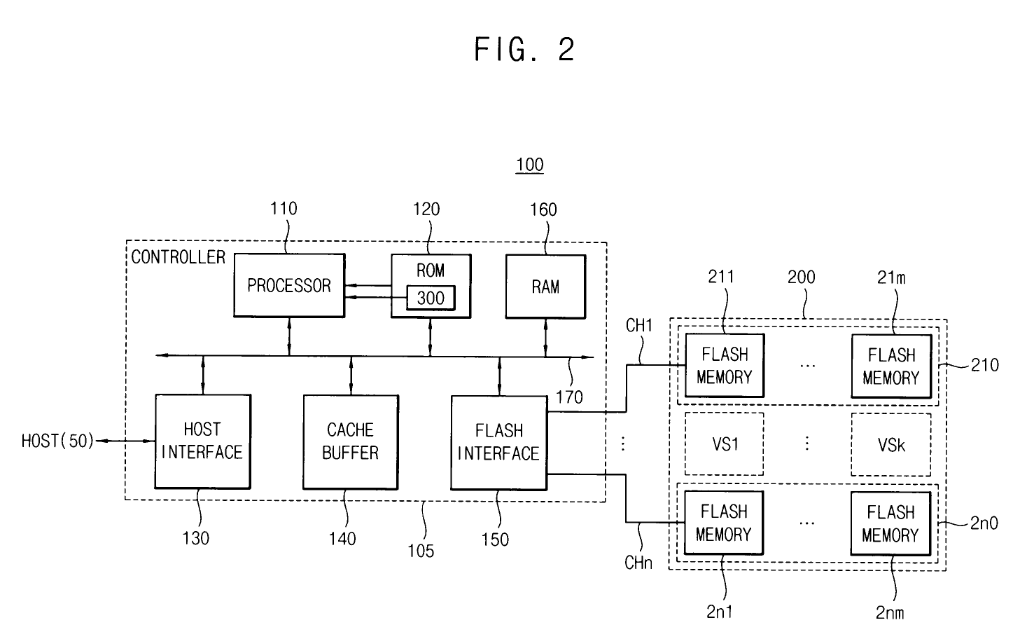

FIG. 2 is a block diagram illustrating an example of the storage device of FIG. 1 according to some embodiments.

Referring to FIG. 2, the storage device 100 may include a controller 105 and a storage media 200.

The storage media 200 may include a plurality of flash groups 210˜2n0. Each of the flash groups 210˜2n0 is connected to the controller 105 through a corresponding one of a plurality of channels CH1˜CHn. The flash group 210 may include a plurality of flash memories 211˜21m, and the flash group 2n0 may include a plurality of flash memories 2n1˜2nm. In some embodiments, the storage media may provide a plurality of virtual storages VS1˜VSk to the host 50. Each of the flash memories 211˜21m, . . . , 2n1˜2nm may be a NAND flash memory. The NAND flash memory may be a single level cell (SLC) flash memory or a multi level cell (MLC) flash memory.

A flash group 210˜2n0 may include a plurality of flash memories 211˜21m, 2n1˜2 nm. Each of the flash groups 211˜21m, 2n1˜2nm may be the same type of non-volatile memory. For example, each of the flash memories 2n1˜2nm in the flash group 2n0 may be SLC flash memory, MLC flash memory, One-NAND flash memory, PRAM or MRAM. The type of non-volatile memory of each flash group 210˜2n0 may differ. In some embodiments, some of the flash groups may include the same type of non-volatile memory, while other flash group(s) may include other types of non-volatile memories. In some embodiments, one of the channels CH1˜CHn may be connected to a flash group including SLC flash memories, another channel of the channels CH1˜CHn may be connected to a flash group including the MLC flash memories, and still another channel of the channels CH1˜CHn may be connected to a flash group including One-NAND flash memories. Alternatively, each channel may be connected with single-level flash memories or multi-level flash memories. The multi-level flash memories may be configured to store M-bit data in each memory cell, where M is an integer greater than or equal to 2.

The controller 105 may include a processor 110, a read-only memory (ROM) 120, a host interface 130, a cache buffer 140 and a flash interface 150. The controller 105 may further include a random access memory 160.

The host interface 130 may exchange data with the host according to a communication protocol under control of the processor 110. In some embodiments, the communication protocol may be one of USB protocol, MMC protocol, PCI protocol, PCI-E protocol, ATA protocol, SATA protocol, ESATA protocol, Parallel-ATA protocol, SCSI protocol, ESDI protocol and IDE protocol. The type of communication protocol used is not limited to the examples described herein.

The data input from the host 50 through the host interface 130 or the data to be transferred to the host 50 may be transferred through the cache buffer 140. In some embodiments, the data transferred to and from the host 50 may not be transferred via a system bus 170 under control of the processor 110.

The cache buffer 140 may temporarily store data transferred between the host 50 and flash memories 211˜21m, . . . , 2n1˜2nm, and/or may store programs running in the processor 110. The programs running in the processor 110 may be stored in the flash memories 211˜21m, . . . , 2n1˜2nm and/or in the ROM 120.

The cache buffer 140 is a kind of buffer memory that may be implemented with a volatile memory. For example, the cache buffer 140 may include an SRAM or a DRAM. In some embodiments, the cache buffer 140 may be located outside of the controller 105.

The flash interface (or a memory interface) 150 performs interfacing between the controller 105 and the flash memories 211˜21m, . . . , 2n1˜2nm for storing data. The flash interface 150 may be configured for supporting at least NAND flash memory, One-NAND flash memory, MLC flash memory and/or SLC flash memory. The types of flash memory that the flash interface 150 is capable of supporting are not limited to the examples described herein.

Although not illustrated in FIG. 2, the controller 105 may further include an error correction code (ECC) engine for correcting errors in the flash memories 211˜21m, . . . , 2n1˜2nm. The ECC engine may be implemented by hardware/circuitry in a manner known in the art.

The RAM 160 may be used to increase the speed of updating data stored in the flash memories 211˜21m, . . . , 2n1˜2 nm. The RAM 160 may also temporarily store programs running or to be run in the processor 110. For example, when a size of the data to be updated in one of the flash memories 211˜21m, . . . , 2n1˜2nm or across one or more flash memories 211-21m is greater than a size of a block of that flash memory or flash memories, the data in the flash memory or flash memories that will not be updated is moved to the RAM 160. The area to be updated in the flash memory or flash memories may then be erased. In some embodiments, the data that was moved to the RAM 160 may thereafter be moved back to the flash memory or flash memories as well. In some embodiments, the data that was moved to the RAM 160 is copied to the newly erased blocks in the flash memory or flash memories, which originally stored the data. In these embodiments, the data that was temporarily stored in the RAM 160 may then be stored in the same physical locations in the blocks and the mapping tables for that temporarily stored data will not have to be updated. In other embodiments, the data that was moved to the RAM 160 is copied to a different flash memory or flash memories or to a different location in the same flash memory or flash memories. For example, the data that was moved to the RAM 160 may be copied to the same flash memory or flash memories from which it was first moved, but since the amount of data is smaller than the original amount of data in the flash memory, one or more of the physical locations at which the copied data is stored may be different from the physical locations at which the data was originally stored. In these embodiments, the mapping tables for the flash memory or flash memories may be updated.

The ROM 120 may provide a program to the host 50 as a form of the firmware 300, and the program may allow the host 50 to create a virtual storage VS (or virtual drive) with the storage device 100. The firmware 300 may be loaded into the processor 100 or may be loaded into the RAM 160 and may be run in the controller 105 when the storage device 100 is booted (e.g. when the storage device 100 is connected to the host 50).

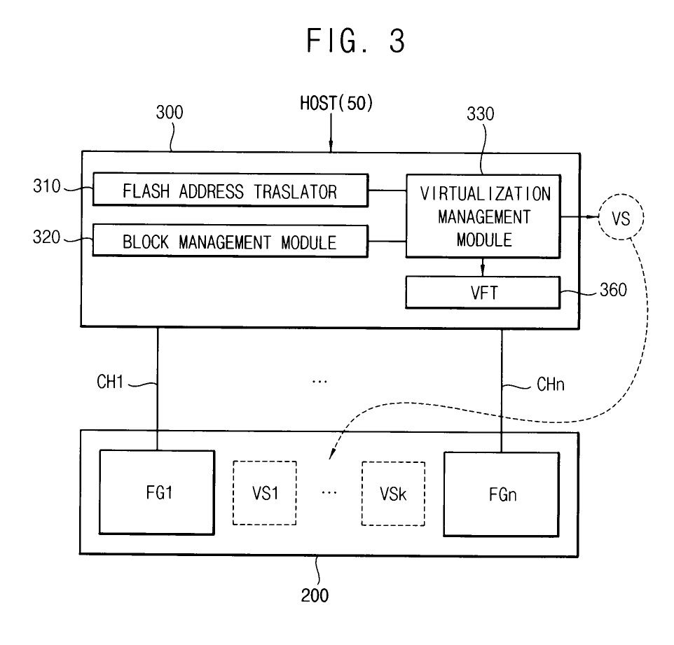

FIG. 3 illustrates an example of the firmware 300, which may constitute software code stored in the ROM 120 (and possibly transferred to RAM 160 for faster access) in FIG. 2 and implemented by processor 110.

Referring to FIG. 3, the firmware 300 manages the flash memories 211˜21m, . . . , 2n1˜2nm. The firmware 300 may include a flash address translator 310, a block management module 320 and a virtualization management module 330. In FIG. 3, the flash memories 211˜21m, . . . , 2n1˜2nm which are managed by the firmware 300 are represented as the flash groups FG1˜FGn.

The flash memories 211˜21m, . . . , 2n1˜2 nm may receive logical addresses from the host 50 in response to a reaD_REQUEST or a write request from the host 50. The logical addresses stored in the host 50 that correspond to the flash memories 211˜-21m, . . . , 2n1˜2nm do not necessarily have a one-on-one match with the physical addresses of the flash memories 211˜21m, . . . , 2n1˜2nm. The flash address translator 310 converts the logical addresses from the host 50 to corresponding physical addresses of the flash memories 211˜21m, . . . , 2n1˜2nm. The flash address translator 310 may use an address mapping table in which the logical addresses and the corresponding physical addresses are written and maintained. The address mapping table may have various sizes, for example, according to the mapping unit(s) used (e.g. page, block, memory cell array, etc.). In some embodiments, the address mapping table may have various mapping schemes according to the use of different mapping units. In some embodiments, the address mapping table may run on the controller 105.

The address mapping method may be one of page mapping method, block mapping method, and hybrid mapping method. A page mapping table is used in the page mapping method. The page mapping table is used for performing mapping operation by unit of page, and the page mapping table stores logical pages and corresponding physical pages. A block mapping table is used in the block mapping method. The block mapping table is used for performing mapping operation by unit of block, and the block mapping table stores logical blocks and corresponding physical blocks. The hybrid mapping method uses the page mapping method and the block mapping method simultaneously or in conjunction with one another.

The firmware 300 includes a block management module 320. Memory blocks of the flash memory may have defects, and a memory block having a defect is referred to as a bad block. The bad block may be generated due to various reasons including, but not limited to, column fail, disturbance and wear-out.

The bad blocks or portions thereof may not be capable of reliably storing data (e.g., a defect in the bad block prevents proper programming, long term storage and/or reading of data in a portion of the bad block). A flash memory may include a reserved area that comprises one or more reserved blocks for replacing the bad blocks. A flash memory may also include a user area, which does not include the reserved blocks, that comprises one or more data blocks. For example, a cell area of the flash area may include the user area and the reserved area. A user (e.g. a host, an end-user, etc.) may not perceive or identify or be able to access the reserved blocks, and may only be able to access the user area to store data. In some embodiments, data stored in a newly determined bad block are moved to free blocks or blocks which were previously reserved blocks and now have been made available. It should be noted that during operation data blocks, free blocks and/or reserved blocks may change their status. A free block may be programmed to become a data block. A data block may be labeled as dirty (e.g., a dirty block) and put in a queue for erasure. Dirty blocks may be erased during an inactive period of the flash memory and become free blocks (ready to accept new data). In addition, firmware 300 may swap reserved blocks for other blocks in the flash memory. For example, a wear leveling operation may determine that a block with a large amount of erasures should be swapped for a reserved block, making the reserved block a free block or a data block, and the block with a large amount of erasures a reserved block. Thus the reserved blocks need not be a fixed physical portion of memory, but may be a number of blocks set aside by the firmware 300 for future use. The reserved blocks may also be used by the flash memory for storing non-user data such as flash translation tables, block erase counts, read counts, etc. The non-user data may be inaccessible by a user.

The block management module 320 may register bad blocks or may replace the bad blocks with reserved blocks when a program operation or an erase operation fails in response to a write request to the flash memories 211˜21m, . . . , 2n1˜2nm. The block management module 320 may manage wear leveling of the flash memories 211˜21m, . . . , 2n1˜2nm to increase life span of the flash memories 211˜21m, . . . , 2n1˜2nm. In some embodiments, the block management module 320 may merge blocks of the flash memories 211˜21m, . . . , 2n1˜2 nm when updating data in the flash memories 211˜21m, . . . , 2n1˜2nm.

The virtualization management module 330 may provide at least one virtual storage VS1˜VSk to the host 50 via one (intervening flash memory) of the flash memories 211˜21m, . . . , 2n1˜2nm in response to a virtualization request from the host 50 or an application running on the host 50. For example, the virtualization management module 330 may create a virtual storage VS in one of the flash memories 211˜21m, . . . , 2n1˜2nm and designate a plurality of blocks in the flash memory to store the data to be stored in the virtual storage VS. The virtualization management module 330 may also generate a virtualization file table (VFT) 360 for associating data stored in the virtual storage VS with the corresponding physical addresses of the corresponding flash memory (at least one of the flash memories 211˜21m, . . . , 2n1˜2nm). For example, an application or host 50 accessing the virtual storage will associate the data in the virtual storage with a virtual address. That virtual address may be mapped in the VFT 360 to one or more corresponding physical addresses in one or more of the flash memories 211˜21m, . . . , 2n1˜2nm at which the actual data is stored.

In some embodiments, in response to a request to delete data in the virtual storage VS, the virtualization management module 330 may generate a virtual trim VTRIM command for effecting the erasure one or more memory blocks in the corresponding flash memory (that correspond to the VS). In some embodiments, the virtualization management module 330 may monitor the states of the flash memories 211˜21m, . . . , 2n1˜2nm, and provide an erase command to the corresponding flash memory when the corresponding flash memory is in an idle state (or ready state). For example, a VTRIM command may result in denoting one or more blocks of the VS as dirty (for example, by updating a table in RAM 160). The block management module 320 of firmware 300 may erase the dirty blocks of the VS after determining an idle time of the flash memory device (e.g., flash memory chip, package or memory module) which contains these dirty blocks. The block management module 320 may group the dirty blocks of the VS with normal dirty blocks (such as those blocks resulting from updating user data in a data block, as described herein). Thus, normal garbage collection processes may be used to erase the dirty blocks of the VS and convert these dirty blocks of the VS to free blocks (which may no longer be associated with the VS.

The flash memories 211˜21m, . . . , 2n1˜2nm may have some restrictions with respect to overwriting data stored in blocks in the flash memories 211˜21m, . . . , 2n1˜2nm. For example, in order to overwrite data in one of the flash memories 211˜21m, . . . , 2n1˜2nm, the corresponding data in that flash memory may need to be erased first. In some embodiments, this is referred to as an erase-before-write operation. The flash memories 211˜21m, . . . , 2n1˜2nm may require more time in data write (program) operation than a DRAM, because the flash memories 211˜21m, . . . , 2n1˜2nm may need to erase the data in the block where write data will be stored. Rather than overwriting data, the system may track free blocks and write updated data to a free block, convert such free block to a new data block (and update an address translation table to associate the virtual or logical address of the data with the new data block, and label the old data block as a dirty block. The dirty block may be erased at a later time, such as an idle time of the flash memory. Therefore, the writing of updated data may not need to wait for an erasure period.

In an exemplary erase operation, a memory cell located in the physical addresses is reset to an erase state. The memory cell may be physically initialized as part of the erase operation. The erase operation may be part of a garbage collection operation or may be initiated separately thereof. The erase operation may physically initialize the memory cell, but may have no impact on the logical address associated with the memory cell. If an erase is performed on a memory cell without updating the mapping table to remove the association between the physical address of the memory cell and a corresponding logical address, the user may receive incorrect information when trying to access the data at that logical address.

A trim operation may be performed on both the logical addresses and the physical addresses corresponding to the data to be deleted. In an exemplary trim operation, data in a memory cell located at a physical address is physically initialized by the trim operation and the relationship between the logical address and the physical address at which the memory cell is located is erased. For example, an entry in a mapping table that associates the logical address of VS data with the physical address is deleted from the mapping table, and the memory cell located at the physical address is initialized. In some embodiments, the trim operation may cause the entry in the mapping table to be marked as “dirty” or as “to be erased”, and the memory cell is initialized during the next garbage collection operation or an erase operation is performed during the next idle time of the corresponding flash memory.

The flash memory may be capable of increasing a maximum number of write and read operations in the flash memory cell by using the trim operation. In some embodiments, the flash memory is capable of increasing the speed of writing data in the flash memory cell when data is capable of being written in the flash memory cell without an additional erase operation after the trim operation or the need for an erase-before-write operation

In some embodiments, the host 50 recognizes the virtual storage VS in the storage device 100 as a virtual image file. In these embodiments, the trim operation may not be able to be performed in the virtual storage VS. The host 50 may only be aware of a virtual image file that has been created that represents the virtual storage VS and does not recognize the flash memory or underlying architecture enabling the virtual storage VS. In these embodiments, a virtual trim VTRIM command may be used to delete data in the virtual storage VS. The virtual trim VTRIM command is an internal trim command that is performed on an area set as the virtualization storage in the storage device supporting virtualization memory. The virtualization management module 330 may generate a virtual trim VTRIM command for erasing a memory block of a corresponding flash memory used for virtual storage VS, including initializing the memory cells at the physical addresses corresponding to the data in the virtual storage VS to be deleted, by referring to the VFT 360. Through the virtual trim VTRIM command, an internal trim operation may be performed on memory cells in the virtual storage VS.

In some embodiments, the virtual trim VTRM command is provided to the corresponding flash memory without regard to the state of the corresponding flash memory. In some embodiments, the virtual trim VTRM command may be performed in the corresponding flash memory when that flash memory is in the idle state. For example, the virtual trim VTRM command may be provided to a corresponding flash memory without regard to the state of the corresponding flash memory, and the virtual trim VTRIM command may be latched in the corresponding flash memory until the corresponding flash memory transitions to the idle state. In another embodiment, the virtual trim VTRIM command may be provided to a corresponding flash memory without regard to the state of the flash memory, and the logical addresses corresponding to the data may be marked as “dirty” or “to be erased” without regard to the state of the flash memory. In this embodiment, an erase operation of the memory cells corresponding to the marked logical addresses may be latched in the corresponding flash memory until that flash memory is in an idle state.

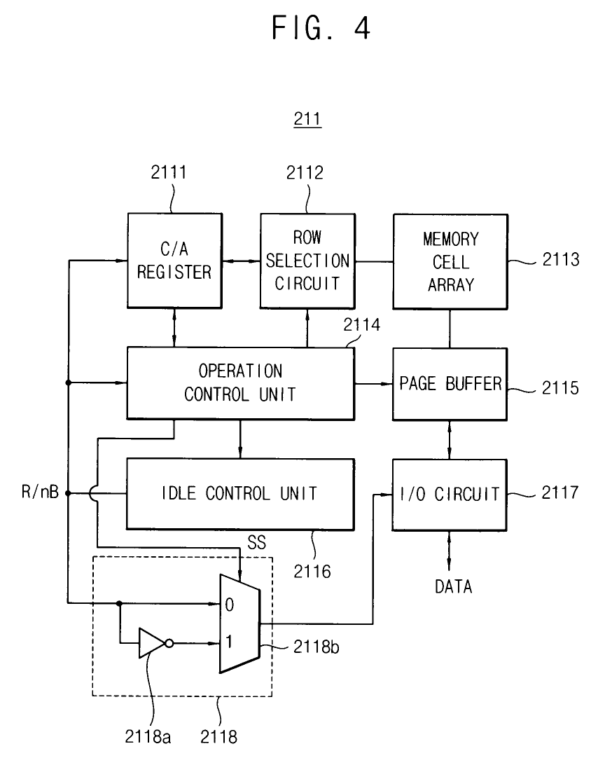

FIG. 4 is a block diagram illustrating one of the flash memories included in the storage media in FIG. 2 according to some example embodiments.

In FIG. 4, the flash memory 211 is depicted. Other flash memories may have substantially the same configuration as the flash memory 211.

Referring to FIG. 4, the flash memory 211 may include a command/address register 2111, a row selection circuit 2112, a memory cell array 2113, an operation control unit 2114, a page buffer 2115, an idle control unit 2116, an input/output (I/O) circuit 2117, and a selection unit 2118.

The memory cell array 2113 may include a plurality of memory cells arranged in a matrix. Each memory cell may store 1-bit data or M-bit data, where M is an integer greater than or equal to 2. The memory cell array 2113 may be a three-dimensional structure or a two-dimensional structure. The row selection circuit 2112 may generate signals for selecting and driving of rows of memory cells in response to addresses received from the command/address register 2111. The command/address register 2111 may be configured to receive a command and an address in response to a ready/busy signal R/nB generated by the idle control unit 2116. Although not illustrated in FIG. 4, the command/address register 2111 may distinguish between commands and addresses by a combination of control signals, such as /CE, /RE, /WE, CLE, and ALE. In various embodiments, these control signals may be provided to both the command/address register 2111 and the operation control unit 2114.

When the ready/busy signal R/nB indicates that the flash memory device 211 is in idle (ready) state, the command/address register 2111 may latch a received address and transmit the latched address to the row selection circuit 2112. In some embodiments, although the read/busy signal R/nB indicates that the flash memory device 211 is in a busy state, the command/address register 2111 may latch the address but not transmit the latched address to the row selection circuit 2112. In these embodiments, the latched address may be sent from the command/address register 2111 to row selection circuit 2112 when or after the read/busy signal R/nB changes from the busy state to the idle state. For example, the command/address register 2111 may receive and latch the address regardless of the state of the flash memory device, but may output the latched address to the row selection circuit 2112 based on the read/busy signal R/nB.

When the ready/busy signal R/nB indicates that the flash memory device 211 is in the idle state, the command/address register 2111 may latch the command and transmit the command to the operation control unit 2114. In some embodiments, although the read/busy signal R/nB may indicate that the flash memory device 211 is in busy state, the command/address register 2111 may latch the command but not transmit the command to the operation control unit 2114. In these embodiments, the latched command may be sent from the command/address register 2111 to the operation control unit 2114 when or after the indication of the read/busy signal changes from the busy state to the idle state. For example, the command/address register 2111 may receive and latch an issued command regardless of the state of the flash memory device but may output the latched command to the operation control unit 2114 based on the ready/busy signal R/nB.

The idle control unit 2116 may generate the ready/busy signal R/nB under the control of the operation control unit 2116, which indicates a busy state or an idle state of the flash memory 211. The ready/busy signal R/nB may be sent to the controller 105 in FIG. 2 through the selection circuit 2118 and the I/O circuit 2117 as the ready/busy signal R/nB. The ready/busy signal R/nB may be also provided to one or both of the command/address register 2111 and the operation control unit 2114. The operation control unit 2114 may receive the latched command from the command/address register 2111 when the ready/busy signal R/nB indicates the idle state. The operation control unit 2114 may control the flash memory 211 to perform operations in response to the received command, such as a program operation, a read operation, and an erase operation. The page buffer 2115 may temporarily store data to be written to or to be read from memory cell array 2113 and may be controlled by the operation control unit 2114.

In some embodiments, when the ready/busy signal R/nB indicates that the flash memory device 211 is in the idle state, the operation control unit 2114 may receive the latched command from the command/address register 2111, and may provide the selection unit 2118 with a selection signal SS having a logic level according to the kind of received command. For example, the selection signal SS may have a logic low level when the operation control unit 2114 receives a command other the virtual trim VTRM command. For example, the selection signal SS may have a logic high level, when the operation control unit 2114 receives a command corresponding to the virtual trim VTRM command. In other embodiments, the selection signal SS may have a logic high level when the operation control unit 2114 receives any command other than the virtual trim VTRIM command and may have a logic low level when the operation control unit 2114 receives the virtual trim VTRIM command.

The selection unit 2118 may include an inverter 2118a and a multiplexer 2118b. The multiplexer 2118b may select one of the ready/busy signal R/nB and an inversion signal of the ready/busy signal R/nB in response to the selection signal SS, and provide the selected one of the signals to the I/O circuit 2117. The inverter 2118a may invert the ready/busy signal R/nB to output the inversion signal to the multiplexer 2118b. The multiplexer 2118b may select the inversion signal of the ready/busy signal R/nB to be provided to the I/O circuit 2117 when the selection signal SS has logic high level. The multiplexer 2118b may select the ready/busy signal R/nB to be provided to the I/O circuit 2117 when the selection signal SS has logic low level. In other embodiments, the multiplexer 2118b may select the ready/busy signal R/nB to be provided to the I/O circuit 2117 when the selection signal SS has a logical high level and may select the inversion signal of the ready/busy signal R/nB to be provided to the I/O circuit 2117 when the selection signal SS has a logical low level.

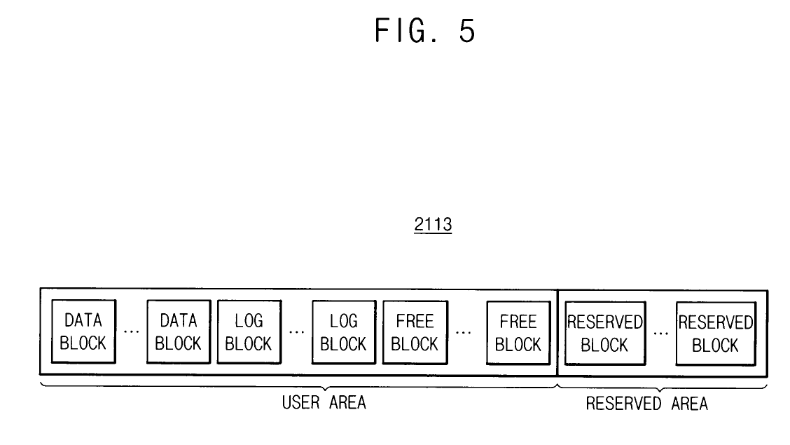

FIG. 5 is a block diagram illustrating an example of the memory cell array in FIG. 4.

Referring to FIG. 5, the memory cell array 2113 may be divided into a USER AREA and a RESERVED AREA. The USER AREA includes at least one memory block. Memory blocks in the USER AREA may be classified according to a purpose. For example, in a case of hybrid mapping scheme, memory blocks may be divided into a data block DATA BLOCK, a LOG BLOCK and a FREE BLOCK. User data may be stored in the DATA BLOCK. The log block LOG BLOCK may be used for modifying the data stored in the DATA BLOCK. During write operations, some of the FREE BLOCKS may be allocated as a LOG BLOCK associated with a DATA BLOCK having data to be updated. Later, this new LOG BLOCK may be converted to the DATA BLOCK associated with it, or this LOG BLOCK and this DATA BLOCK may be merged to create a new DATA BLOCK from a FREE BLOCK and the old DATA BLOCK and LOG BLOCK may be labeled as dirty to be later made into FREE BLOCKS. A mapping table may be updated to reflect the new association of the logical address of the data and the new DATA BLOCK. For further details of an exemplary mapping scheme, see U.S. Pat. No. 6,938,116, the contents of which are incorporated by reference in their entirety. The USER AREA may be located at a certain location in the memory cell array 2113 or may correspond to a certain number (e.g., a predetermined number or a number selected by a user or a host) of blocks. The blocks of the USER AREA may be reassigned to blocks of the RESERVED AREA and vice versa, in which case the physical location of the USER AREA and the RESERVED AREA would not be fixed within the memory cell array 2113. For example, in response to a wear leveling algorithm, the firmware 300 may switch blocks of the USER AREA and blocks of the RESERVED AREA to evenly distribute erasure amounts between blocks of the memory cell array 2113.

As mentioned above, defects may occur due to various factors in the DATA BLOCK, the LOG BLOCK and the FREE BLOCK. For example, defects from column fail, disturbance and/or wear-out may make a block defective. The RESERVED AREA may include at least one reserved data block that can be used to replace defective blocks in the USER AREA. The RESERVED AREA is configured to account for a desired (or, alternatively a predetermined) ratio of the memory cell array.

When there is a defective data block, data stored in the defective data block may be lost. In order to prevent the loss of data in a defective block, the data stored in the defective DATA BLOCK may be stored in a RESERVED BLOCK in the RESERVED AREA. The designation of the RESERVED BLOCK may be changed to a DATA BLOCK, and the designation of the defective block or another DATA BLOCK may be changed to a RESERVED BLOCK. This change may be performed by updating a correspondence relationship between logical addresses and physical addresses. For example, a logical address corresponding to the defective memory block may be changed to correspond to a normal DATA BLOCK. The normal DATA BLOCK may be an available free DATA BLOCK that has been designated as a RESERVED BLOCK and that is used to store the data that had been stored in the defective block. In this case, the designation of the available free DATA BLOCK is changed to a DATA BLOCK in the USER AREA. In some embodiments, the designation of the defective DATA BLOCK may be changed to a reserved block in the RESERVED AREA. The designations of the blocks and locations of the data stored within the blocks are updated in the mapping table as they are changed. When there is an access request from external device (e.g., a host), the flash address translator refers to the mapping table to provide the physical block address corresponding to the requested logical block address in the flash memory.

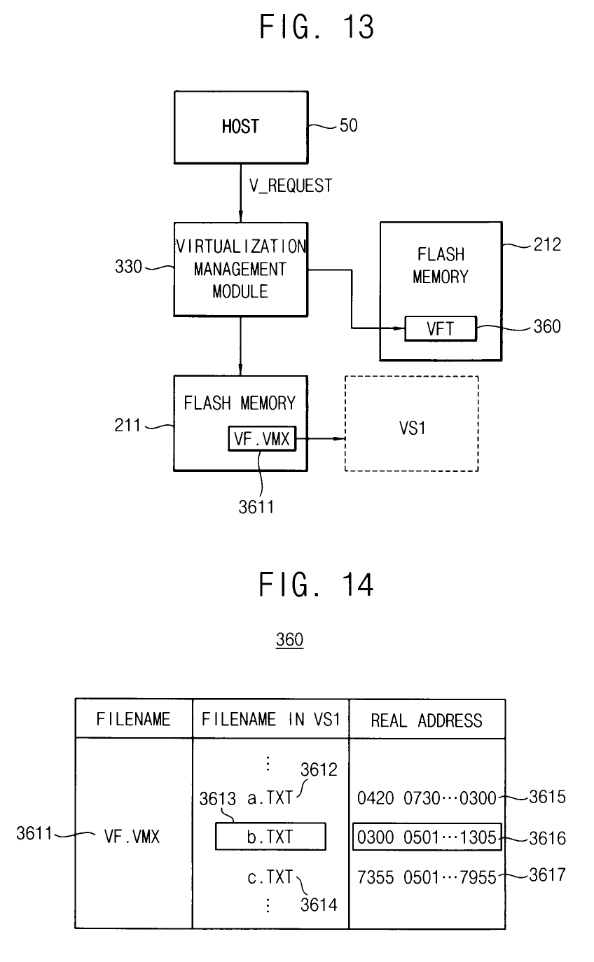

In some embodiments, when there is a defective memory block in a flash memory which stores entries in the VFT 360, when the virtualization management module 330 is providing virtual storage VS to the host 50, the data stored in the defective memory block in the flash memory may be moved to a reserved block, such that the reserved block stores the entries of the VFT 360. The VFT 360 may be updated by updating the associations between the data in the virtual storage VS (the virtual addresses) and the physical addresses corresponding to the data in the virtual storage VS, to prevent the loss of data in the virtual storage VS according to some example embodiments. The structure of the VTF 360 will be discussed below, with reference, for example, to FIG. 12.

For example, when a virtual trim VTRIM command is received corresponding to data stored in the virtual storage at one or more data blocks in a flash memory, a free block or the reserved block may be used to update the flash memory. In some embodiments, the one or more data blocks which contain the data referenced in the virtual trim VTRIM command may be set as “dirty” blocks or blocks “to be erased.” When the flash memory is in an idle state, or when the flash memory is undergoing a garbage collection operation, the blocks of and/or portions of the data block(s) which are not referenced in the virtual trim VTRIM command may be copied to one or more free blocks or reserved blocks in the flash memory or in another flash memory. The memory cells(s) in the data block(s) containing the data referenced in the virtual trim VTRIM command may then be physically initialized, and the data blocks may be designated as free blocks or reserved blocks. In some embodiments, the data that was moved may be copied back to the free blocks or reserved blocks that had previously contained the data in the virtual storage. The VFT 360 may then be updated by updating the entries relating to the moved data in the virtual storage VS and the physical addresses corresponding to the data in the virtual storage VS to prevent the loss of the data in the virtual storage VS.

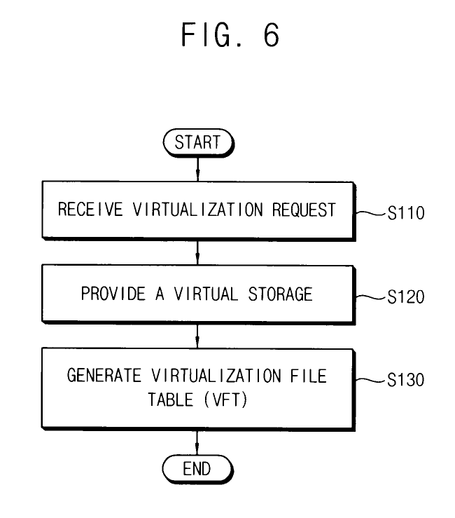

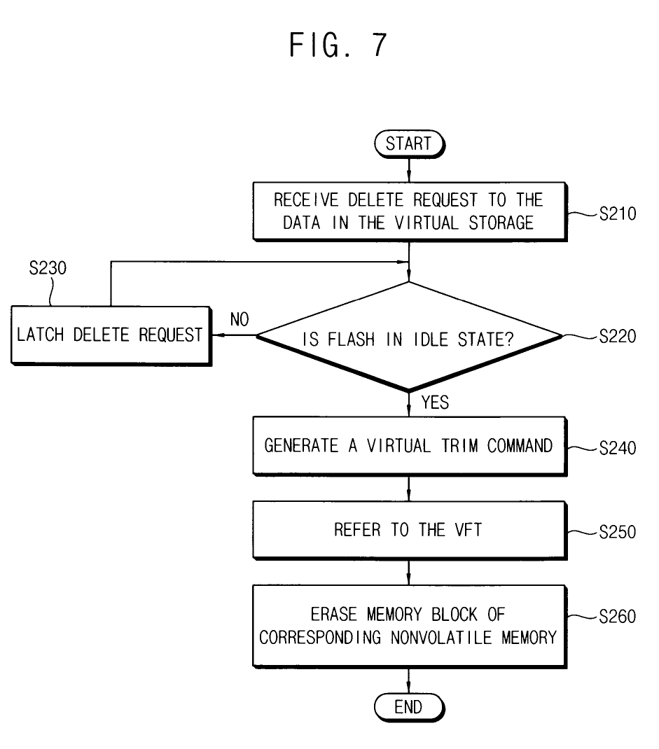

FIGS. 6 and 7 is a flow chart illustrating a method of virtualizing a storage device according to some example embodiments. Hereinafter, there will be a detailed description on an exemplary method of virtualizing a storage device with reference to FIGS. 1 through 7.

In some embodiments, the virtualization management module 330 in the firmware 300 receives a virtualization request V_REQUEST from an OS 60 in the host 50 (5110). At this time, the flash address translator 310 in the firmware 300 may receive a logical address corresponding to an intervening flash memory of the flash memories 211˜21m, . . . , 2n1˜2nm. The flash address translator 310 may provide the virtualization management module 330 with physical addresses corresponding to the logical address of the intervening flash memory, and the virtualization management module 330 may generate at least one virtual storage VS1˜VSk in a flash memory corresponding to the physical addresses (S120). When a data write request to the at least one virtual storage VS1˜VSk is received from the host 50, the virtualization management module 330 may generate the VFT 360 (or, alternatively update the VFT 360 if it has already been created) to associate the logical address of the data in the at least one virtual storage VS1˜VSk with the physical addresses of the corresponding flash memory (S130). The VFT 360 may be stored in one of the flash memories 211˜21m, . . . , 2n1˜2nm. In some embodiments, the VFT 360 may be stored in a flash memory belonging to the same flash group which includes the flash memory that stores the at least one virtual storage VS1˜VSk. In other embodiments, the VFT 360 and the at least one virtual storage VS1˜VSk may be stored in different flash groups.

In some embodiments, as shown in FIG. 7, the controller 105 (or the virtualization management module 330) receives a delete request D_REQUEST referencing data in the at least one virtual storage VS1˜VSk (S210). The flash address translator 310 may also receive logical addresses of the intervening flash memory corresponding to the data referenced in the delete request D_REQUEST. The flash address translator 310 may provide the virtualization management module 330 with physical addresses corresponding to the logical addresses of the intervening flash memory. The virtualization management module 330 may receive the corresponding physical addresses and determine whether the intervening flash memory is in idle (ready) state or not (S220).

When the intervening flash memory is not in the idle state (No in S220), (e.g., the intervening flash memory is performing one of program operation, reading operating and erase operation), the delete request D_REQUEST is latched. The latching of the delete request D_REQUEST may be performed in the virtualization management module 330 or in the command/address register 2111. When the delete request D_REQUEST is latched in the virtualization management module 330, the delete request D_REQUEST may not be sent to the intervening flash memory while the ready/busy signal R/nB indicates that the intervening flash memory is in the busy state. When the delete request D_REQUEST is latched in the intervening flash memory, a command corresponding to the delete request D_REQUEST such as the virtual trim VTRIM command may not be sent from the command/address register 2111 to the operation control unit 2114 while the ready/busy signal R/nB indicates that the intervening flash memory is in the busy state.

In some embodiments, when the intervening flash memory is not in the idle state, a virtual trim VTRIM command may be sent from the command/address register 2111 to the operation control unit 2114. The virtual trim VTRIM command will cause the physical memory locations in the data blocks that correspond to the data to be deleted in the virtual storage to be marked or flagged as “dirty” or “to be erased.” In these embodiments, the controller may erase the marked or flagged data blocks as part of a normal garbage collection operation when the flash memory is in an idle state or as part of an erase operation if enough of the memory cells in the data blocks are marked or flagged as “dirty” or “to be erased.” For example, the controller may perform an erase operation when the flash memory is in the busy state, interrupting other operations or other queued operations, if ⅕ of the memory cells or 1/5 of data blocks in the flash memory contain memory cells marked or flagged as “dirty” or “to be erased.” The amount of flagged or marked memory cells or data blocks containing flagged or marked memory cells needed to prompt an erase operation is not limited to the examples described herein, and may be set by users or may be a standard number determined based on performance and efficiency considerations of the flash memory.

In some embodiments, when the intervening flash memory is in the idle state (Yes in S220), (e.g., the intervening flash memory is not performing one of program operation, reading operating and erase operation), the processor 110 may generate a virtual trim VTRIM command (S240) referencing the data in the delete request D_REQUEST. The virtualization management module 330 may search the VFT 360 in response to the virtual trim VTRIM command (S250). The virtualization management module 330 may provide the command/address register 2111 with physical addresses corresponding to one or more memory blocks of the intervening flash memory that include the data in the at least one virtual storage VS1˜VSk that was referenced in the virtual trim VTRIM command. In a mapping table corresponding to the virtual storage VS, the logical addresses corresponding to the provided physical addresses may be flagged or marked as “dirty” or “to be erased.” The virtualization management module 330 may also perform an erase operation on the marked or flagged memory cells in the memory blocks of the intervening flash memory that include the marked physical addresses referenced in the virtual trim VTRIM command (S260). In some embodiments, the erase operation is part of a garbage collection operation of the flash memory that includes the virtual storage. The erase operation functions in the same manner whether it is part of the garbage collection operation or whether it is initiated separately from a garbage collection operation.

The erase operation may involve copying the data in the virtual storage that is not referenced in the virtual trim VTRIM command to free blocks or reserved blocks in the intervening flash memory or to another flash memory in the flash group. The VFT 360 is then updated by updating the data in the at least one virtual storage VS1˜VSk and the physical addresses corresponding to the data in the virtual storage VS. The flash memory including the virtual storage VS that contains the data referenced in the virtual trim VTRIM command may then be erased. For example, all of the memory cells in the memory blocks of the flash memory including the virtual storage VS containing data to be deleted may be physically initialized. In some embodiments, the flash memory including the virtual storage with the data to be deleted is erased before the VFT 360 is updated. In some embodiments, instead of being stored in another flash memory, the data that is not to be erased is copied to the RAM 160 and then copied back to the flash memory in which it was originally stored.

In some embodiments, memory blocks of the intervening flash memory may be divided into a hot data area and a cold data area according to the access frequency to those memory blocks. The hot data area includes memory blocks having an access frequency higher than a reference frequency, and the cold data area includes memory blocks having an access frequency lower than the reference frequency. A VFT with respect to the hot data area may be stored in a volatile memory (for example, RAM 160 in FIG. 2), which may be updated easily, and a VFT with respect to the cold data area may be stored in one of the flash memories in the storage media 200. The VFT stored in the volatile memory may be backed up during operation and/or during a power-off procedure in one of the flash memories in the storage media 200.

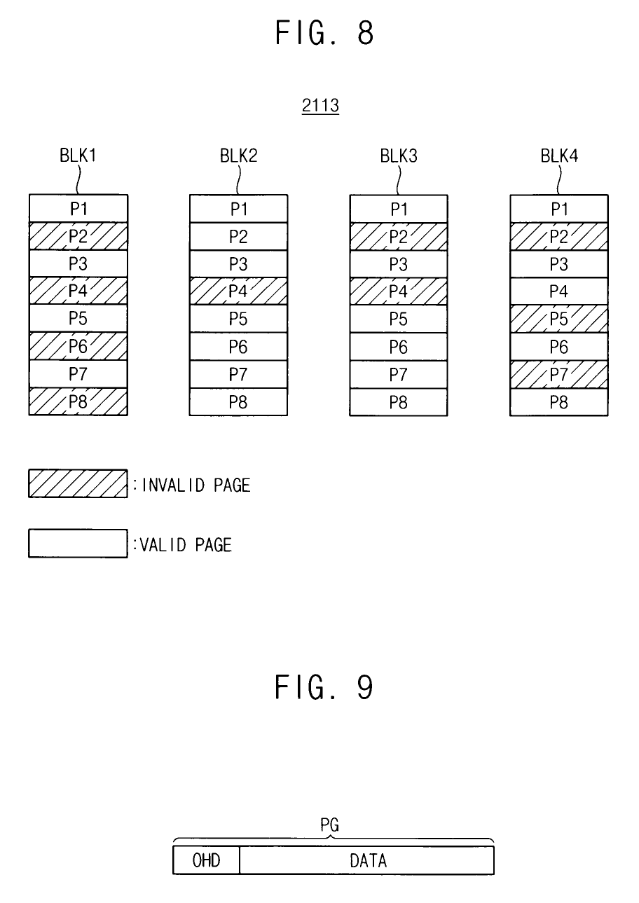

FIG. 8 is a diagram for explaining garbage collection performed in a flash memory device according to some example embodiments.

FIG. 9 is a diagram illustrating an exemplary page in FIG. 8.

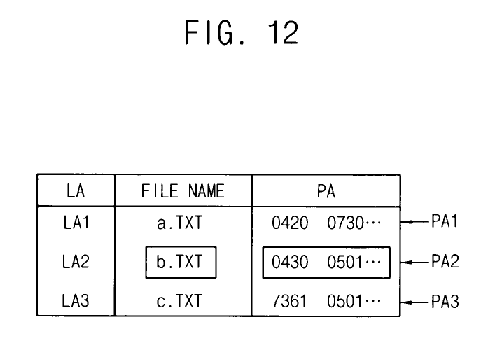

Referring to FIGS. 8 and 9, the memory cell array 2113 may be divided into a plurality of blocks BLK1, BLK3, BLK3 and BLK4. Each of the blocks BLK1, BLK3, BLK3 and BLK4 may be further divided into a plurality of pages P1˜P8. A page PG may be further divided into one or more sectors. In FIG. 11, one sector is included in one page PG, and the sector includes date DATA and overhead data OHD associated with the data DATA. The overhead data OHD may store an error correction code (ECC) calculated from the DATA during programming operation, a count of the number of times the block has been erased and re-programmed, control flags, operating voltage levels, and other information associated with the date such as valid or invalid information of the page PG. The type of information included in the overhead data OHD is not limited to the examples described herein.

When a block in a flash memory is updated with new data, the page written with the original data is considered to be invalid, and a new page is allocated so that the new data can be written on the new page. If the flash memory has insufficient available storage space to store new data, the available storage space of the flash memory may be increased by performing garbage collection.

Generally, garbage collection is performed by generating and managing a block list including blocks with one or more invalid pages. In some embodiments, both a block list including blocks with one or more invalid pages and a block list including garbage blocks having invalid pages only are managed. A shortage of blocks to be allocated for storing data may be addressed by garbage collection, and the number of blocks having invalid pages may be reduced. A valid page may include original data that has not been updated, or it may be a free block or reserved block that has not yet had data written to it.

In FIG. 8, the block BLK1 has four invalid pages P2, P4, P6 and P8, the block BLK2 has one invalid page P4, the block BLK3 has two invalid pages P2 and P4, and the block BLK4 has three invalid pages P2, P5 and P7. In an example garbage collection, since the block BLK1 has the greatest number of the invalid pages, the garbage collection operation may be performed on the block BLK1 by selecting the block BLK2 having the least number of invalid pages, and allocating the block BLK2 to the block BLK1 such that the valid pages P1, P3, P5 and P7 in the block BLK1 may be copied to the block BLK2. Then the block BLK1 may be erased. In some embodiments, the block BLK1 may then also be designated as a free block or a reserved block.

Data stored in a flash memory that an operating system (OS) “deletes” and considers available space may actually still be maintained in the flash memory device. A TRIM command (operation) may provide a way to instruct flash memory devices about which logical addresses for which the flash memory device no longer has to maintain an active logical to physical address mapping. When a flash memory supports a TRIM operation, a sector (or a page) that the operating system (OS) “deletes” and consider available space may be physically erased.

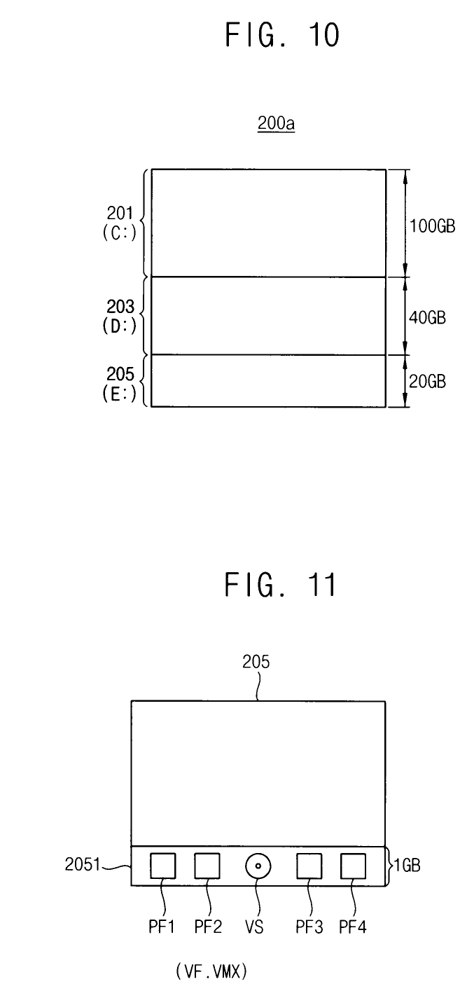

FIGS. 10 and 11 are diagrams for explaining virtual memory (or virtual disk) according to some example embodiments.

Referring to FIGS. 10 and 11, a SSD 200a may have a data storage capacity of 200 GB. The SSD 220a may be divided into three areas: directory C 201 having data storage capacity of 100 GB, directory D 203 having data storage capacity of 40 GB and directory E 205 having data storage capacity of 10 GB. In some embodiments, the directory E 205 may include twenty flash memory devices (such as a flash memory 2051), each having data storage capacity of 1 GB. A virtual disk (or virtual storage) VS may be generated in the flash memory device 2051 by allocating some portions of the flash memory device 2051 in response to a virtualization request V_REQUEST from a user or an OS. In some embodiments, the flash memory device 2051 may include physical files PF1˜PF4. The user or OS that sent the virtualization request V_REQUEST will attempt to access the data stored in the virtual storage by referring to virtual addresses associated with the data. The virtual addresses may be logical addresses. The data in virtual storage is associated with both a physical address corresponding to its physical location in the flash memory device 2051 and a virtual address that is used by a host or an OS to access the data. In some embodiments, the virtual addresses of the data in the virtual disk VS and the corresponding physical addresses associated with the respective virtual addresses and indicating the location of the data in the flash memory device 2051 are stored in a virtualization file table VFT 360.

In some embodiments, the virtual disk VS is stored as a virtual image file VF.vmx in the flash memory device 2051. When data in the virtual disk VS is to be accessed, the virtual addresses corresponding to the data in the virtual disk VS are converted to physical addresses corresponding to the virtual image file VF.vmx. When data (or a file) in the virtual disk VS is deleted by OS, the data (or a file) in the virtual disk VS may be modified instead of being deleted in the flash memory device 2051 in cases when the virtual trim VTRIM operation is not supported. In some embodiments, when data (or files) are written in the virtual disk VS, the virtual addresses of the data written in the virtual disk VS and the corresponding physical addresses in the flash memory device 2051 associated with the respective virtual addresses are stored in the virtualization file table VFT 360.

FIG. 12 is a diagram illustrating a virtualization file table (VFT) according to some example embodiments.

The virtualization file table VFT may provide address translations from virtual addresses (e.g., used by a host to access a file in the virtual disk) to corresponding groups of physical addresses PA. The VFT of FIG. 12 provides mapping information for an exemplary virtual disk VS includes three files a.TXT, b.TXT and c.TXT. The files a.TXT, b.TXT and c.TXT correspond to logical addresses LA1, LA2 and LA3 and are stored at physical address groups PA1, PA2 and PA3, respectively, of the flash memory device 2051. A single logical address may be used to access a file that is stored at multiple physical addresses. The VFT may map multiple physical addresses to a single logical address, and the single logical address may be the only identifier necessary to access a file of the virtual storage VS. Each physical address stored in the VFT may correspond to a page address of the memory. Alternatively, each physical address may correspond to a page address and column address (selecting a portion of the physical page), or it may correspond to a block address. For easiness of description, the following description is limited to file a.TXT and associated physical and logical addresses, but should be understood to be equally applicable to other files and other portions of a VFT. The example of FIG. 12 shows file a.TXT stored in a physical address group PA1, comprising physical address 0420, 0730, etc. When a host attempts to access file a.TXT, it sends a request to access the virtual disk VS at logical address LA1. Memory controller 105 may receive the VS access request and in response, access VFT to look up the physical addresses of physical address group PA1 to determine the location of file a.TXT and access file a.TXT. The order of the physical addresses of the physical address group PA1 need not be in sequential order for each subsequent part of the file a.TXT. The physical addresses may be selected by block management module 320 upon creation and or movement of parts of file a.TXT (e.g., by accessing the next available FREE BLOCK in a free block queue or next available page). The physical locations of the parts of the file a.TXT may be moved as part of normal block management of the flash memory, such as to avoid undesired read disturbance errors and/or for wear leveling purposes. E.g., upon determining a particular physical address storing a portion of file a.TXT has been read a certain number of times (which may be a predetermined number or a number generated by an algorithm), the block management module may move that portion of file a.TXT to another physical address and update the VFT to reflect the new physical address location of that portion of file a.TXT. As another example, upon determining a first block (which may be a FREE BLOCK or DATA BLOCK) has been erased a relatively higher amount of times than a second block storing data of file a.TXT, the block management module may move the data of the second block to this first block and update the VFT to reflect the new physical address of the portions of the file a.TXT in the first block (other address translations for data which is not part of file a.TXT may be implemented as well). During this movement of the portion of the file of a.TXT, the system may also check the portion of the file of a.TXT for errors using error correction code associated with that portion of the file of a.TXT, and if an correctable error is found, may correct the faulty bit, and store corrected data in the new location. Moving all or parts of the portions of the file a.TXT may result in the sequence of parts of the file a.TXT to be changed from a first sequence to a second, different sequence (e.g., with respect to an addressing value of the physical addresses, the ordering of parts of the file a.TXT may be rearranged). The ordering of the physical locations of the parts of the file a.TXT (whether originally in sequential order or in no-sequential order) may be rearranged as part of normal block management of the flash memory. The movement (and/or rearrangement and/or reordering) of the portions of the file a.TXT may be performed multiple times as desired. The virtualization file table VFT includes the logical addresses LA of the files in the virtual disk VS and the physical addresses PA in the flash memory device 2051. The virtualization file table VFT may be stored in a flash memory device different from flash memory device 2051, and/or within a volatile memory which may provide faster access and translation time (e.g., RAM160). In some embodiments, the virtualization file table VFT is stored in a flash memory device in the same flash group as the flash memory device 2051. In other embodiments, the virtualization file table VFT may be stored in a flash memory device that is not in the same flash group as the flash memory device 2051.

In some embodiments, when the host 50 sends a request to delete the file b.TXT in the virtual disk VS, the logical address LA2 is accessed for deleting the file b.TXT in the virtual disk VS. The virtualization management module 330 may refer to the virtualization file table VFT to access the physical address PA2 in the flash memory device 2051 corresponding to the logical address LA2. The virtualization management module 330 may then generate a virtual trim VTRIM command to erase the data stored at the physical address PA2 in the flash memory device 2051 and erase the association between the logical address LA2 and the physical address PA2. The operation of the virtual trim VTRIM command will be explained further below.

FIG. 13 illustrates that the storage device provides the virtual storage in the storage system in FIG. 1 according to some example embodiments.

FIG. 14 illustrates a virtualization file table (VFT) according to some example embodiments.

Referring to FIG. 13, the host 50 (or the OS 60) transmits a virtualization request V_REQUEST to the virtualization management module 330. The virtualization management module 330 provides a virtual storage VS1 to the host via the flash memory 211 (e.g. an intervening flash memory). The virtual storage VS1 may not be identified externally; in some embodiments, virtual storage VS1 may be a storage area that may only be identified or accessed through the OS 60 in the host 50. The virtual storage VS1 may be recognized as a virtual image file 3611 in the intervening flash memory 211. In some embodiments, the virtualization management module 330 may generate the VFT 360 for associating the data in the virtual storage VS1 with the physical addresses of the intervening flash memory 211 and may store the VFT in another flash memory 212.

Referring to FIG. 14, an exemplary virtualization file table VFT 360 is stored in the flash memory 212. The VFT 360 may be created by the virtualization management module 330 along with the virtual storage VS in response to a virtualization request V_REQUEST from the host. The host 50 (or OS 60) may only see a virtual image file VF.VMX in response to its virtualization request V_REQUEST. The exemplary VFT 360 associates the virtual image file VF.VMX seen by the host with the virtual data (represented by logical addresses in the VFT 360). The VFT 360 also associates the logical addresses that represent the virtual data stored in the virtual image file VF.VMX with the physical addresses at which the first data of the virtual file is stored. For example, the VFT 360 in FIG. 14 associates the virtual image file 3611 with several virtual files with logical addresses 3612, 3613 and 3614 included in the virtual image file 3611, and also associates the virtual files 3612, 3613, and 3614 with the physical address groups 3615, 3616 and 3617, respectively. Each physical address group 3615, 3616 and 3617 comprise one or more physical addresses.

The VFT 360 may also contain metadata for each entry in the table. For example, for each virtual file, metadata may be stored that indicates the length of the file. In other embodiments, each virtual file may be associated with a physical address that includes a pointer to the next physical location at which data of the file is stored. In this embodiment, each virtual file in the virtual storage may also include an end-of-file (EOF) marker to indicate the end of the file. In some embodiments, the physical locations at which data of a file are stored may be non-sequential in the flash memory. By associating the virtual file with a physical address at which the first data of the virtual file is stored, the VFT 360 may associate the physical addresses corresponding to a virtual file with the virtual file.

Metadata for the virtual image file 3611 may also include a length of the file. Alternatively, the virtual image file 3611 may include an end-of-file (EOF) marker to indicate the end of the virtual image file 3611. The EOF marker for the virtual image file 3611 may be different from or may be the same as the EOF marker for virtual files.

In some embodiments, only the virtualization management module 330 may access the VFT 360. In some embodiments, all or most of the components of the firmware 300 have access to the VFT 360. For example, both the virtualization management module 330 and the block management module 320 have access to the VFT 360, as the block management module may perform or initiate garbage collection operations that take into account whether a physical or logical address in the VFT 360 has been marked or flagged as “dirty” or “to be erased.”

Data at the physical addresses 3615, 3616, and 3617 may not be initialized through a trim operation from the host 50 because the host 50 does not typically have access to the physical addresses 3615, 3616, and 3617 or the corresponding virtual files 3612, 3613, and 3614. However, the data in the physical addresses 3615, 3616, and 3617 may be initialized (e.g., the memory cell at the physical addresses 3616 physically erased) through the virtual trim VTRIM command by referring to the VFT 360, which associates the data in the virtual storage VS1 with the physical addresses of the intervening flash memory 211.

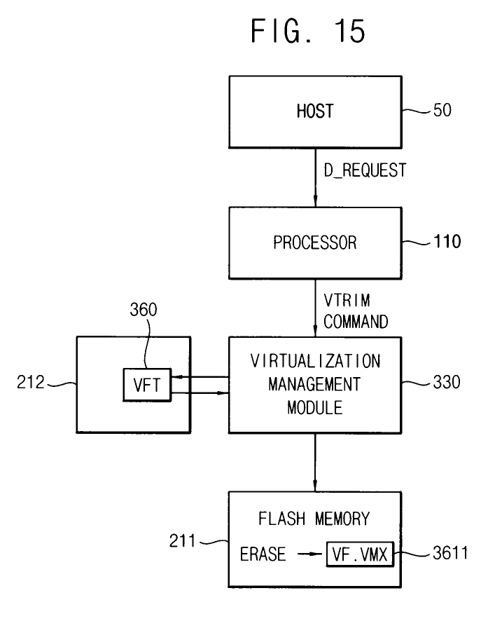

FIG. 15 illustrates a virtual trim operation performed on data in the virtual storage in the storage system in FIG. 1 according to some example embodiments.

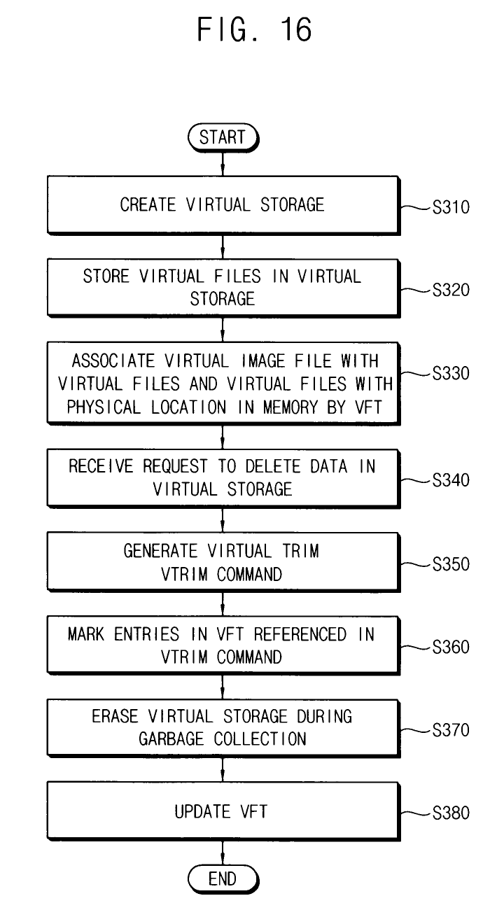

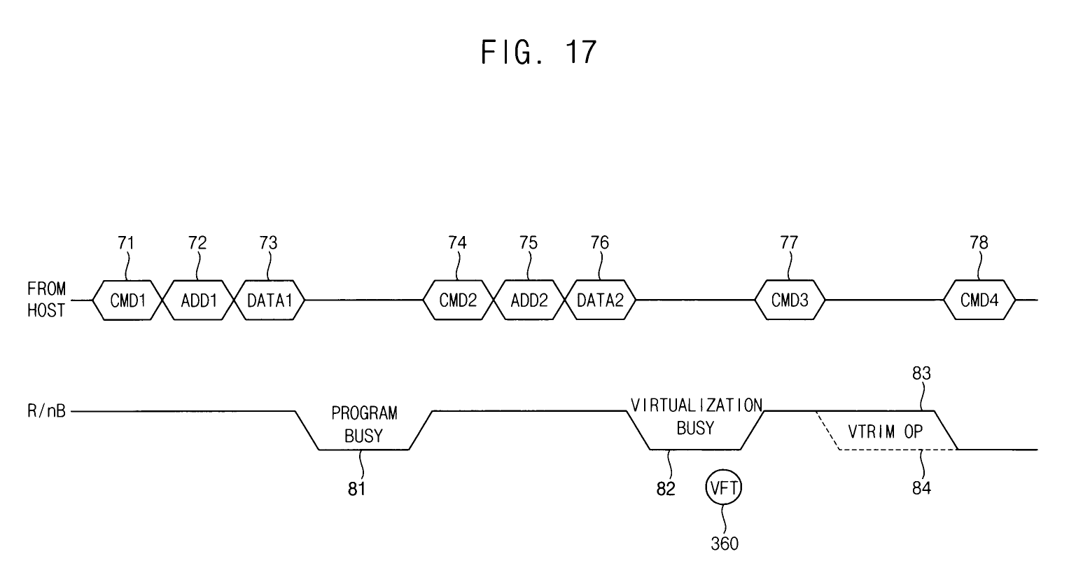

FIG. 16 is a flowchart showing an exemplary operation of a virtual trim VTRIM command with reference to FIGS. 14 and 15.

Referring to FIG. 15, the host 50 (or, the OS 60) transmits a delete request D_REQUEST referencing data in the virtual storage VS1 to the processor 110. The processor 110 may transmit the delete request D_REQUEST to the virtualization management module 330. The virtualization management module 330 may refer to the VFT 360 to determine that the virtual storage VS1 is represented by virtual image file 3611 and stored in flash memory 211. The virtualization management module 330 may the refer to other parts of the firmware 300 or the flash memory 211 to determine whether the flash memory 211 including the virtual image file 3611 is in an idle state or not. When the intervening flash memory 211 is in the idle state, the processor 110 may generate and send the virtual trim VTRIM command to the virtualization management module 330. As a result of the virtual trim VTRIM command, t the memory block of the intervening flash memory 211 that includes the virtual image file 3611 may be erased (that is, the memory block of the intervening flash memory 211 is physically initialized) and the data that was not referenced in the delete request D_REQUEST may have been moved to another flash memory.

FIG. 16 illustrates a flowchart explaining an exemplary process of deleting virtual data using the virtual trim VTRIM command. First, a virtualization request V_REQUEST is sent by the host 50 (or, the OS 60), and the virtualization management module 330 creates a virtual storage VS in the flash memory 211. (S310). A plurality of physical addresses in the flash memory are allocated to the virtual storage VS. The host 50 may view the virtual storage VS as a single virtual image file 3611. The virtualization management module 330 also stores one or more virtual files 3612, 3613, 3614 in the virtual storage. (S320). The data of each of the files is stored in memory cells at physical address groups 3615, 3616, 3617. A virtualization file table VFT 360 is also created by the virtualization management module to associate the virtual image file 3611 with virtual files 3612, 3613, 3613 that are stored in the virtual storage VS, and also to associate the virtual files 3612, 3613, 3614 with the physical address groups 3615, 3616, 3617 at which the first data of each of the files is respectively stored. (S330). Each physical address group 3615, 3616 and 3617 comprise one or more physical addresses.

The virtualization management module 330 may then receive a request to delete one or more, or all of the files in the virtual storage. (S340). The virtualization management module 330 may refer to the VFT 360 to determine that the data included in the delete request corresponds to the data stored in the virtual storage VS that is stored in the flash memory 211, and may further refer to the VFT 360 to determine which of the files in the virtual storage VS is to be deleted. For example, the virtualization management module 330 may refer to the VFT 360 to determine that the delete request references virtual file 3616 in the virtual image file 3611 stored in the flash memory 211.

The firmware 300 may generate a virtual trim VTRIM command that references the data included in the delete request D_REQUEST. (S350). The virtual trim VTRIM command may operate to mark the entry for the virtual file 3616 in the VFT 360 as “dirty” or “to be erased.” (S360). The firmware 300 need not erase any portion of the virtual file 3616 at this time. During a subsequent garbage collection operation, the data of the virtual files in the virtual storage that were not marked as “dirty” or “to be erased” are moved to another flash memory and the memory cells storing the data in the files in the VFT 360 that have been marked as “dirty” or “to be erased” are then physically initialized. (S370). This garbage collection operation may be performed during an idle state of the memory 211 (e.g., when the host or other external source is not requesting access to the memory 211. In some embodiments, the memory cells storing the data of the marked files may be erased (e.g., physically initialized). In these embodiments, valid data in the memory blocks containing the memory cells storing the data marked as dirty are copied to other memory blocks in the flash memory 211, or copied to another flash memory altogether, and then the memory blocks including the memory cells containing the data marked as dirty are erased (e.g., the memory cells in those memory blocks are physically initialized). When the host requests deletion of the entire virtual storage VS, all of the memory cells that were allocated for the virtual storage VS, as represented by the virtual image file 3611, may be erased in one or more subsequent garbage collection operations. Garbage collection operations referred to herein may be delayed to occur during an idle time to allow intervening accesses to the memory 211 to occur. Any valid data in blocks to be erased may be moved to free blocks, including valid data which is part of the virtual storage VS. When portions of the data of the virtual storage VS are moved to other physical locations, VFT 360 is updated to associate the new physical location with the appropriate the virtual files of the virtual image file. (S380).

FIG. 17 is a timing diagram for illustrating operation of the storage device according to some example embodiments.

When data is to be programmed into the storage media 200 in the storage device 100 of FIG. 2, the data to be programmed is transmitted from the host 50 to the controller 105. The data transferred from the host 50 may be temporarily stored in the cache buffer 140 through the host interface 130. When the data transferred from the host 50 is stored in the cache buffer 140, the controller 105 may send a serial data input command 71, an address 72, and transferred data 73 to the flash memory 211 through channel CH1 using a predetermined timing sequence. The command/address register 2111 in FIG. 4 may latch the input command 71 and the address 72. The data 73 may be loaded to the page buffer 2115 via the I/O circuit 2117. When the program command 71 is transferred from the command/address register 2111 to the operation control unit 2114, the data 73 may be programmed in the memory cell array 2113 under control of the operation control unit 2114. When the data 73 is being programmed in the memory cell array 2113, the operation control unit 2114 may control the idle control unit 2116 to generate the ready/busy signal R/nB with a level indicating the busy state (81, labeled “Program Busy”). In some embodiments, the operation control unit 2114 may provide the selection unit 2118 with the selection signal SS having logic low level, and the ready/busy signal R/nB with a level indicating the busy state (81) is transferred to the controller 105 via the I/O circuit 2117.

When the flash memory 211 is in the busy state, a virtualization command 74 may be latched in the controller 105. When the state of the flash memory 211 transitions to the idle (ready) state, the virtualization command 74, an address 75 of the flash memory 211 and the data 76 to be stored in the virtual storage may be transferred to the flash memory 211. The virtualization management module 330 may thus provide access of the virtual storage VS1 to the host 50, and generate the VFT 360 to be stored in the flash memory 212. The virtualization management module 330 may provide access of the virtual storage VS1 to the host 50 via the operation control unit 2114, which may control the idle control unit 2116 to generate the ready/busy signal R/nB with a level indicating the busy state (82, labeled “Virtualization Busy”). When the controller 105 receives a delete command referencing data stored in the virtual storage VS1 after the virtualization operation is completed, the virtualization management module 330 may determine whether the flash memory 211 is in the idle state or not.

The virtualization management module 330 (or the processor 110) generates a virtual trim VTRIM command and refers to the VFT 360 to control the operation control unit 2114 of the flash memory 211 such that the memory block of the flash memory 211 that includes the virtual image file 3611 is erased as described with reference to FIG. 16. For example, the memory block of the flash memory 211 containing the virtual image file 3611 is physically initialized. In some embodiments, generation of the virtual TRIM command may include updating a data record (such as a table) to indicate pages and/or blocks including the virtual image file 3611 are dirty, and to allow for erasing such blocks (and creating associated FREE BLOCKS therefrom) containing all or portions of the virtual image file 3611 during normal garbage collection procedures. In some embodiments, the virtual TRIM command is issued from the virtualization management module and sent to the flash memory 211 during an idle state of the flash memory 211. In some embodiments, when the virtual trim VTRIM command is transferred from the command/address register 2111 to the operation control unit 2114, the memory block(s) of the flash memory 211 which includes the virtual image file 3611 is erased under control of the operation control unit 2114. When the memory block of the flash memory 211 is being erased, the operation control unit 2114 controls the idle control unit 2116 to generate the ready/busy signal R/nB with a level indicating the busy state (84, labeled “VTRIM OP”). In some embodiments, the operation control unit 2114 provides the selection unit 2118 with the selection signal SS having logic high level, and the ready/busy signal R/nB with a level indicating the idle state (83) is transferred to the controller 105 via the I/O circuit 2117.

In some embodiments, when the virtual trim VTRIM operation is performed on the memory block(s) of the flash memory 211 which include the virtual image file 3611, the command/address register 2111, the operation control unit 2114, the idle control unit 2116 and the selection unit 2118 receive the ready/busy signal R/nB with a level indicating the busy state (84), while the controller 105 receives the ready/busy signal R/nB with a level indicating the idle state (83). When a command 78 is transferred from the controller 105 to the command/address register 2111, the transferred command 78 may be latched in the command/address register 2111 without being transferred to the operation control unit 2114.

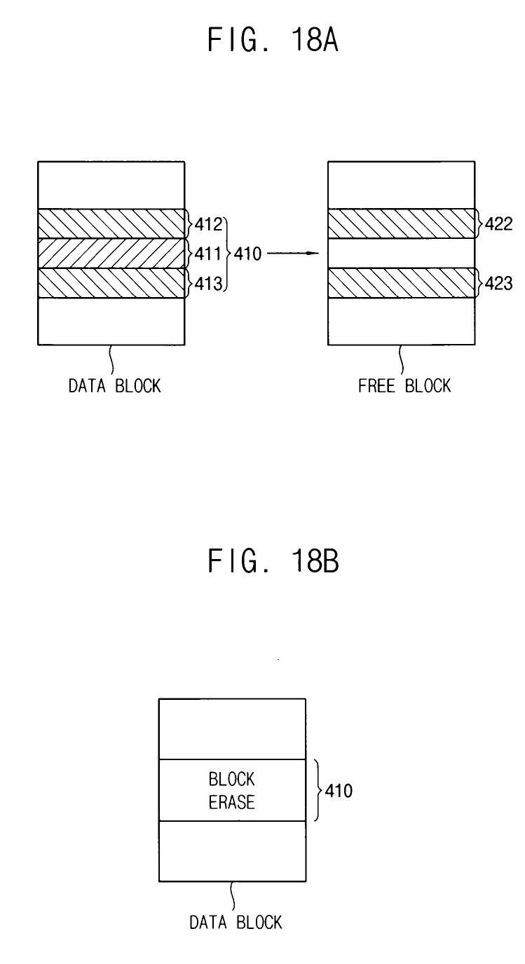

FIGS. 18A and 18B illustrates that the virtual trim command is performed in the flash memory according to some example embodiments.

There will be a description of FIGS. 18A and 18B with reference to FIG. 14.

Referring to FIG. 18A, a block 410 of data block DATA BLOCK includes areas 411, 412 and 413. The area 411 corresponds to the data to be erased in the virtual storage, and the area 411 corresponds to the reference numeral 3163 in FIG. 14. Therefore, the area 411 is designated by the physical address 3616. In addition, the area 412 corresponds to the reference numeral 3162 in FIG. 14 and the area 412 is designated by the physical address 3615. In addition, the area 413 corresponds to the reference numeral 3164 in FIG. 14 and the area 413 is designated by the physical address 3617. When the virtual trim VTRIM operation is performed on the file 3613, the areas 412 and 413 in the block 410, which do not correspond to the data to be erase in the virtual storage, may be copied to areas 422 and 423 of the free block FREE BLOCK, and then the erase operation is performed on the block 410 as illustrated in FIG. 18B.

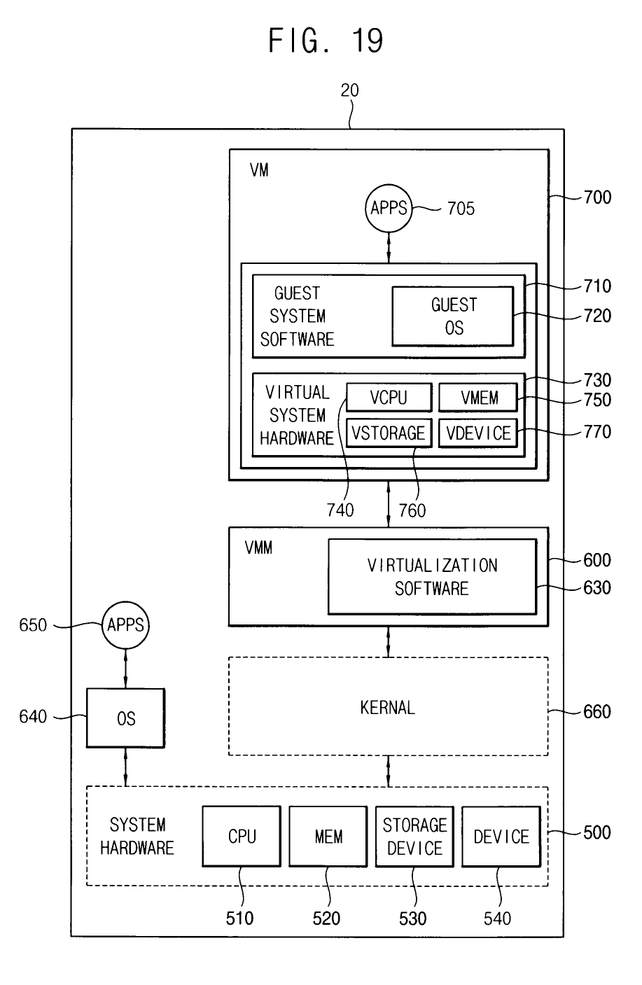

FIG. 19 is a block diagram illustrating a computer system that implements virtualization according to some example embodiments.

Referring to FIG. 19, a computer system 20 that implements virtualization may include a system hardware platform 500, at least one virtual machine (VM) 700 and at least one virtual machine monitor (VMM) 600. The VM 700 and the VMM 600 may be connected to the system hardware platform 500. The computer system 20 may further include an optional kernel 660 (used in non-hosted systems). The computer system 20 may include additional VMs 700 and VMMs 600. In FIG. 18, the VM 700, which in this system is a “guest,” is installed on a “host platform,” or simply “host,” which includes the system hardware 500 and one or more layers or co-resident components including system-level software, such as host operating system (OS) 640 or similar kernel 660, the VMM 600, or some combination of these. As software, code defining VM 700 may ultimately execute on the actual system hardware 500.

As in almost all computers, the system hardware 500 may typically include one or more CPUs 510, some form of memory 520 (volatile and/or non-volatile), one or more storage devices 530, and one or more devices 540, which may be integral or separate and removable. Examples of devices 540 include a user's monitor and input devices such as a keyboard, mouse, trackball, touchpad, etc.

In some embodiments, the VM 700 typically mimics the general structure of a physical computer and as such usually includes both virtual system hardware 730 and guest software 710. The guest software 710 may include guest OS 720 and guest application 705, or may only include the guest OS 720. The virtual system hardware 730 may typically include at least one virtual CPU 740, at least one virtual memory 750, at least one virtual storage device 760 and one or more virtual devices 770. All of the virtual hardware components of VM 700 may be implemented in software to emulate corresponding physical components.

The applications 705 running on the VM 700 function as though run on the system hardware 500. Executable files will be accessed by the guest OS 720 from the virtual memory 750 or the virtual storage device 760, which will be portions of the actual physical storage device 530 or the physical memory 520 allocated to the VM 700.

In some embodiments, the VMM 600 includes a virtualization software 630 and performs interfacing between the VM 700 and the system hardware 500. For example, the virtualization software 630 may manage data transfer between the VM 700 and the storage device 530 and/or the memory 520. Although the VM 700 includes at least one virtual CPU 740, at least one virtual memory 750, at least one virtual storage device 760 and one or more virtual devices 770, the virtualization software 630 included in the VMM 630 may emulate at least one virtual CPU 740, at least one virtual memory 750, at least one virtual storage device 760 and one or more virtual devices 770.

The virtualization software 630 may run on the system hardware 500, and a firmware running the virtualization software 630 may be stored in the storage device 530. For example, the storage device 530 may employ the storage device 100 of FIG. 2, and the storage device 530 may include a controller and a storage media having a plurality of nonvolatile memories (flash memories). The virtualization management module 330 included in the storage device 100 of FIG. 1 may be implemented as a part of the virtualization software 630, and may manage the virtual system hardware 730 on the VM 700. In some embodiments, the virtualization software 630 may provide to the host a VM 700 that may also include the virtual storage 760 via one of the nonvolatile memories in the storage device 530, in response to a virtualization request from the host (or the system OS 640). In some embodiments, the virtualization software 630 may generate the VFT for associating the data in the virtual storage 760 with physical addresses of an intervening nonvolatile memory, and may store the VFT in another nonvolatile memory when one or more applications access the virtual storage 760 and/or write data in the virtual storage 760. In some embodiments, when the applications 705 intend to delete data in the virtual storage 760, the virtualization software 630 may refer to the VFT and erase the data in the virtual storage, including the entry in the VFT associating the virtual addresses and the physical addresses and the data at the physical addresses corresponding to the data to be deleted in the virtual storage 760, using a virtual trim VTRIM command.

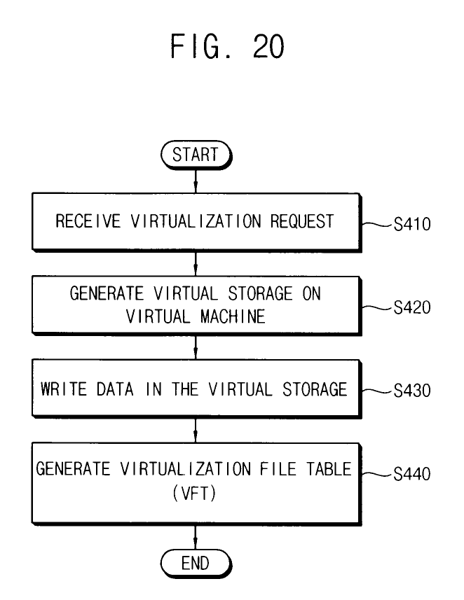

FIG. 20 is a flow chart illustrating a method of writing data in a virtual storage according to some example embodiments.

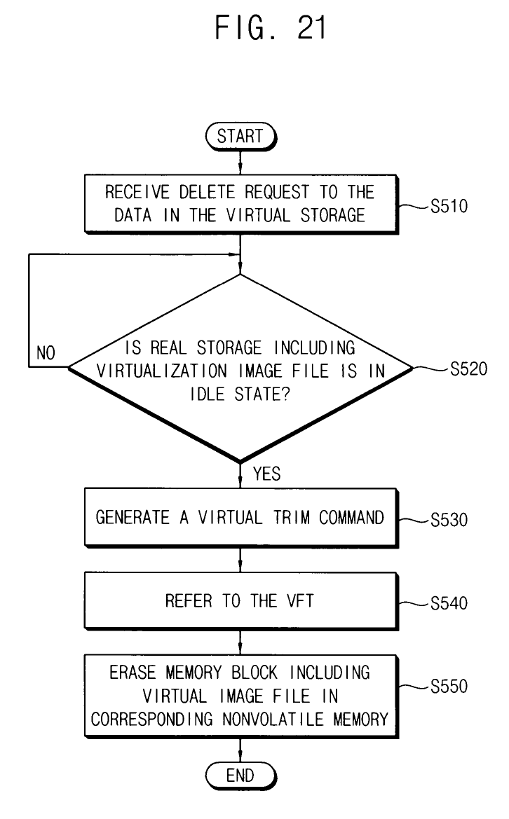

FIG. 21 is a flow chart illustrating a method of deleting data in a virtual storage according to some example embodiments.

Methods of FIGS. 20 and 21 will be described with reference to FIG. 19, although methods of FIGS. 20 and 21 may be applicable to any system supporting virtual storages.

Referring to FIGS. 19 and 20, the OS 640 may receive a virtualization request from the applications 605 (S410). The virtualization software 630 may generate a virtual storage 760 on the virtual system hardware 730 (or on the VM 700) via one of the nonvolatile memories in the storage device 530, in response to the virtualization request (S420). The guest OS 720 may receive a data write request to the virtual storage 760 from the applications 605 to write data in the virtual storage 760 (S430). The virtualization software 630 may generate the VFT for associating the data in the virtual storage 760 with physical addresses of the intervening nonvolatile memory (S440). In some embodiments, the VFT may be stored in another nonvolatile memory.

Referring to FIGS. 19 and 21, the VMM 600 may receive a request from the applications 705 to delete data in the virtual storage 760 (S510). The VMM 600 may determine whether the intervening nonvolatile memory is in the idle state or not (S420). When the intervening nonvolatile memory is in the idle state (Yes in S520), the virtualization software 630 may generate the virtual trim VTRIM command (S530). The virtualization software 630 may refer to the VFT (S540), and erase a memory block of the intervening nonvolatile memory, including the physical addresses corresponding to the data in the virtual storage 760 and the entry in the VFT associating the virtual address with the physical addresses corresponding to the data to be deleted (S550). When the intervening nonvolatile memory is in the busy state (NO in S520), the virtual trim VTRIM command may be latched until the intervening nonvolatile memory transitions to the idle state.

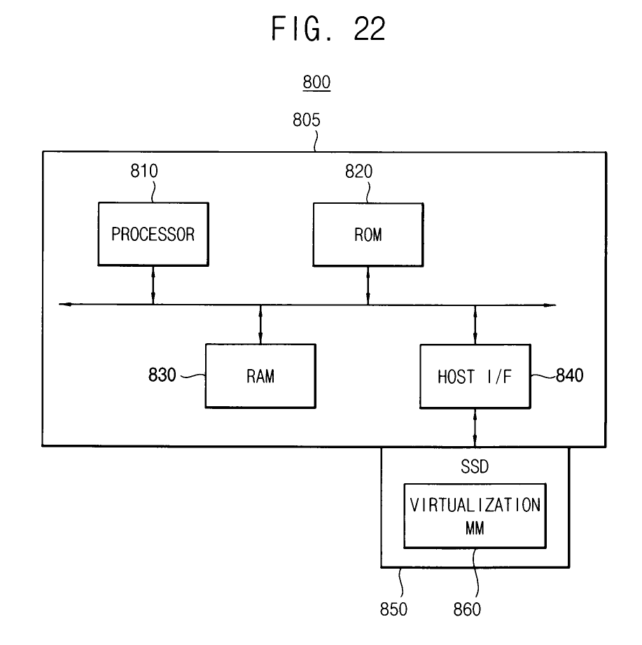

FIG. 22 is a block diagram illustrating an electronic device using a storage device according to some example embodiments.

Referring to FIG. 22, an electronic device 800 may include a host 805 having a processor 810, a ROM 820, a RAM 830a host interface 840. The electronic device may also include a storage device SSD 850.

The processor 810 may access the RAM 830 to execute a firmware code or some other computer code. In some embodiments, the processor 810 accesses the ROM 820 for executing fixed command sequences such as an initializing command sequence or a BIOS sequence.

The host interface 840 may perform interfacing between the host 805 and the storage device 850. The host interface 840 may include a protocol for exchanging data between the host 805 and the storage device 850. The protocol may be one of USB protocol, MMC protocol, PCI protocol, PCI-E protocol, ATA protocol, SATA protocol, ESATA protocol, Parallel-ATA protocol, SCSI protocol, ESDI protocol and IDE protocol. The type of protocol is not limited to the examples described herein.

The storage device 850 may be attachable to the host 805. The storage device 850 may employ the storage device 100 of FIG. 2, and the storage device 850 may include a controller and a storage media having a plurality of nonvolatile memories (flash memories). A virtualization management module 860 included in the storage device 850 may provide virtual storages to the host 805 via one of the nonvolatile memories in the storage device 850, in response to a virtualization request from the host 805. In some embodiments, the virtualization management module 860 may generate the VFT for associating the data in the virtual storage with physical addresses of an intervening nonvolatile memory. In some embodiments, the virtualization management module 860 may erase a memory block of the intervening nonvolatile memory, including the physical addresses corresponding to the data in the virtual storage and the entry in the VFT associating the virtual address and the physical addresses of the data to be deleted, using the VFT and a virtual trim VTRIM command, in response to a request to delete data in the virtual storage.

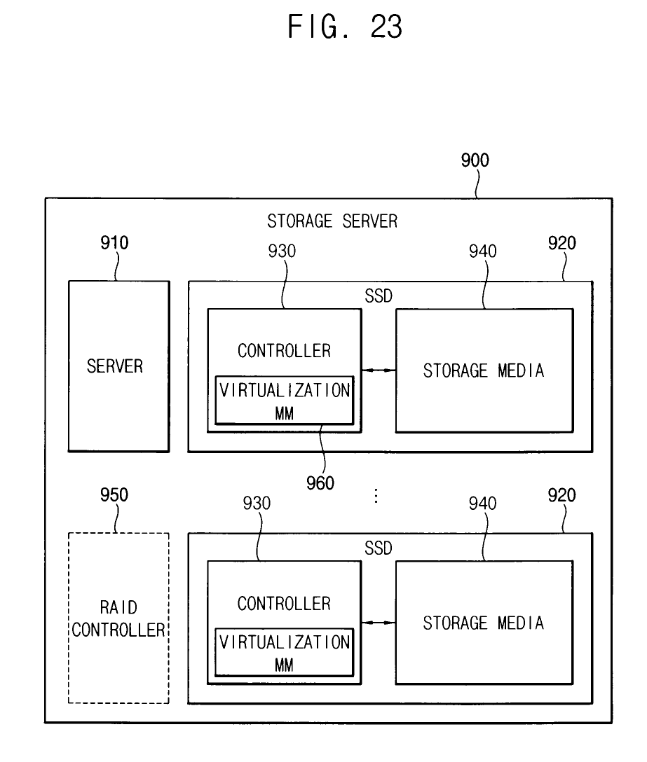

FIG. 23 is a block diagram illustrating an example of a storage server using a storage device according to some example embodiments.

Referring to FIG. 23, a storage server 900 may include a server 910, a plurality of storage devices 920 that store data for operating the server 910 and a raid controller 950 for controlling the storage devices 920. Redundant array of independent drives (RAID) techniques are mainly used in data servers where important data can be replicated in more than one location across a plurality a plurality of storage devices. The raid controller 950 may enable one of a plurality of RAID levels according to RAID information, and may interface data between the server 910 and the storage devices 920. Each of the storage devices 920 may employ the storage device 100 of FIG. 2. For example, each of the storage devices 920 may include a storage media 940 including a plurality of nonvolatile memories (flash memories) and a controller 930 for controlling the storage media.

A virtualization management module 960 included in the controller 930 may provide virtual storages to the server 910 via one of the nonvolatile memories in the storage media 940, in response to a virtualization request from the server 910. In some embodiments, the virtualization management module 960 may generate a VFT for associating the data in the virtual storage with physical addresses of an intervening nonvolatile memory. In some embodiments, the virtualization management module 960 may erase a memory block of the intervening nonvolatile memory, including the physical addresses corresponding to the data in the virtual storage and an entry in the VFT associating a virtual address and the physical addresses of the data to be deleted, using the VFT and a virtual trim VTRIM command, in response to a request to delete data in the virtual storage.

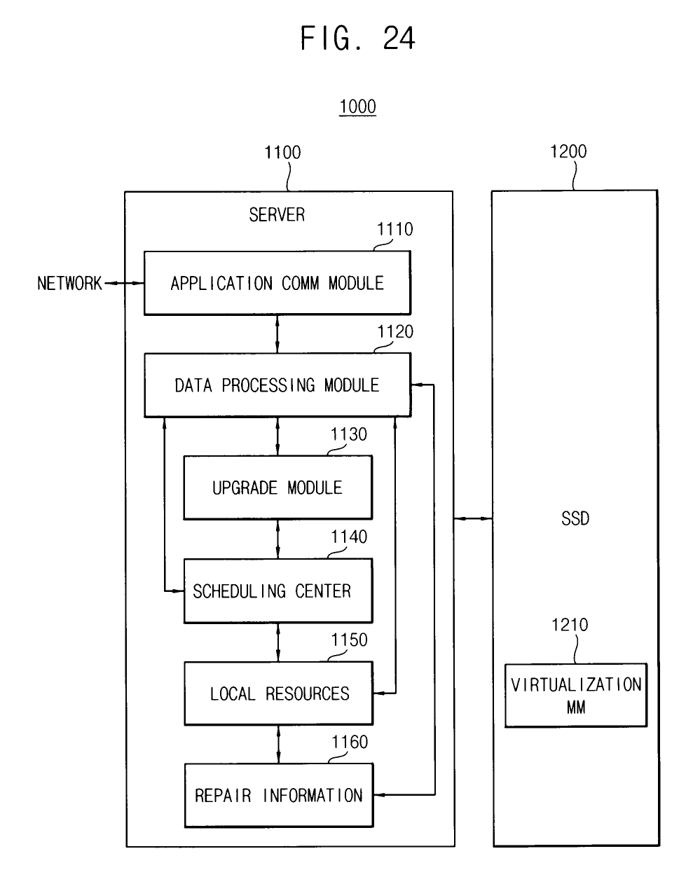

FIG. 24 is a block diagram illustrating an example of a server system using a storage device according to some example embodiments.

Referring to FIG. 24, a server system 1000 may includes a server 1100 and a storage device SSD 1200 which stores data for operating the server 1100.

The server 1100 includes an application communication module 1110, a data processing module 1120, an upgrading module 1130, a scheduling center 1140, a local resource module 1150, and a repair information module 1160.

The application communication module 1110 may be implemented to communicate between the server 1100 and a computing system connected to a network, or may be implemented to communicate between the server 1100 and the storage device 1200. The application communication module 1110 may transmit data or information received through a user interface to the data processing module 1120.

The data processing module 1120 is linked to the local resource module 1150. The local resource module 1150 may provide a user with repair shops, dealers and list of technical information based on the data or information input to the server 1100.

The upgrading module 1130 interfaces with the data processing module 1120. The upgrading module 1130 may upgrade firmware, reset code or other information to an appliance based on the data or information from the storage device 1200.

The scheduling center 1140 may permit real-time options to the user based on the data or information input to the server 1100.

The repair information module 1160 interfaces with the data processing module 1120. The repair information module 1160 may provide the user with information associated with repair (for example, an audio file, video file or text file). The data processing module 1120 may pack associated information based on information from the storage device 1200. The packed information may be sent to the storage device 1200 or may de displayed to the user.

The storage device 1200 may employ the storage device 100 of FIG. 2, and the storage device 1200 may include a controller and a storage media having a plurality of nonvolatile memories (flash memories). A virtualization management module 1210 included in the storage device 1200 may provide virtual storages to the server 1100 via one of the nonvolatile memories in the storage device 1200, in response to a virtualization request from the server 1100. In some embodiments, the virtualization management module 1210 may generate a VFT for associating the data in the virtual storage with physical addresses of an intervening nonvolatile memory. In some embodiments, the virtualization management module 1210 may erase a memory block of the intervening nonvolatile memory, including the physical addresses corresponding to the data in the virtual storage and the entry in the VFT associating a virtual address with the physical addresses of the data to be deleted, using the VFT and a virtual trim VTRIM command, in response to a request to delete data in the virtual storage.

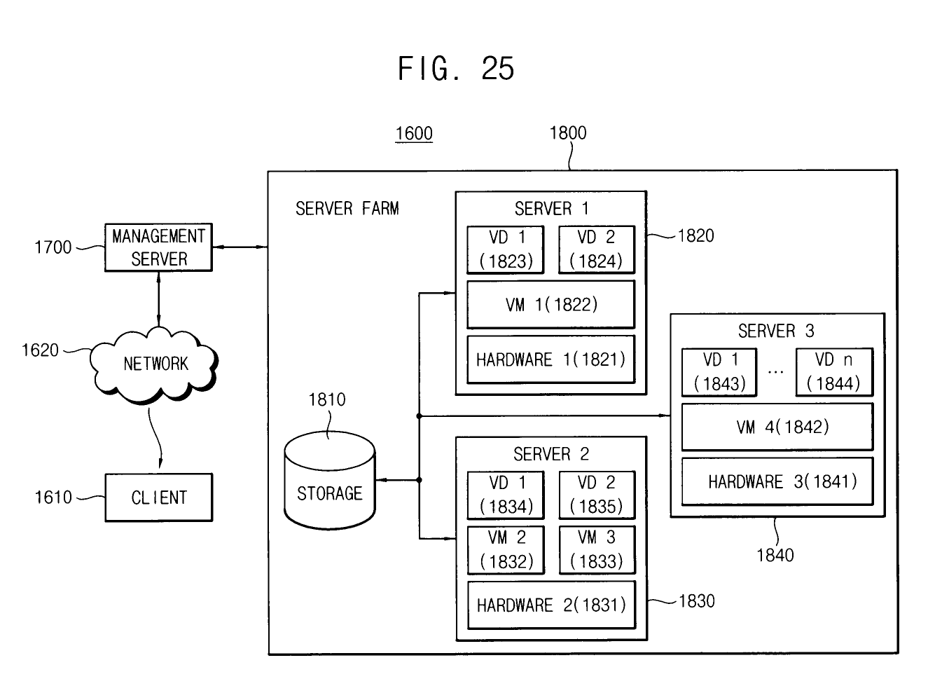

FIG. 25 is a block diagram illustrating an example of a system for providing a cloud computing service according to some example embodiments.

Referring to FIG. 25, a system 1600 includes a client 1610, a management server 1700, and a server farm 1800. The client 1610, the management server 1700, and the server farm 1800 are connected to each other over a network 1620.

Examples of the client 1610 may include a mobile terminal, a digital television, a set-top box, an MP3 player, a portable multimedia player (PMP), a laptop, and the like, which are capable of network access. The client 1610 is not limited to the example devices described herein.

The management server 1700 functions as a gateway or a hub for the server farm 1800, and may manage resources of one or more servers, for example, servers 1820, 1830, and/or 1840. In addition, the management server 1700 may control the one or more servers 1820, 1830, and 1840 to operate a computing service using resource information stored in a storage 1810. Although the management server 1700 is provided externally of the server farm 1800 in the example shown in FIG. 19, the management server 1700 may be configured to be included in the server farm 1800.

The server farm 1800 is a plurality of centralized computer servers. In this example, the server farm 1800 includes servers 1820, 1830, and 1840 and the storage 1810, and provides a computing service to the client 1610. The number of servers is not limited to three, and each is server may have its own operating system or the servers may share an operating system.

In an example where cloud computing is extended from business to business (B2B) to business to customer (B2C), it may be desirable for the speed of responding to a computing service to be fast and efficient; otherwise, private users are likely to be disappointed. In addition, the charge for the computing service should be reasonable. Generally, in the case of a cloud computing service for B2B, a service provider checks a service available at the moment of a computing service request. When a virtual machine needed for the computing service is not present, a new virtual machine may be operated and an operated service may be registered in a list of computing services in use. However, the conventional cloud computing service is not suitable for private users due to a long response time from when the new virtual machine is activated until the computing service that the client requests is provided.

The cloud computing service providing system shown in FIG. 20 may operate to provide the cloud computing service even to private users as well as business users at high speed and at a reasonable cost. For example, the cloud computing service may provide a virtual device that is generated by emulating the virtual machine and operated on a virtual machine. The virtual device may be provided as a computing resource to the client 1610.

The virtual machine may be a virtual computer that multiplexes physical hardware such that a plurality of different operating systems may be operated in a single piece of hardware. The virtual machine may be provided for a business cloud computing service. In comparison, the virtual device may be optimized to customer electronics (CE) that private users generally use. The virtual device may be generated by emulating or simulating a virtual machine in order to multiplex the virtual machine. The virtual device may include, for example, an operating system, a development platform, an application program for CE, and the like. The virtual device may be configured to have a plurality of application programs running thereon. It may appear to the client 1610 that the virtual device operates as a computing service.

Referring again to FIG. 25, the first server 1820 includes first hardware 1821, a first virtual machine 1822, a first virtual device 1823, and a second virtual device 1824. In this example, the first virtual device 1823 and the second virtual device 1824 operate on the first virtual machine 1822.

The second server 1820 includes second hardware 1831, a second virtual machine 1832, a third virtual machine 1833, a first virtual device 1834, and a second virtual device 1835. In this example, the second virtual machine 1832 and the third virtual machine 1833 operate on the second hardware 1831. In some embodiments, the first virtual device 1834 operates on the second virtual machine 1832, and the second virtual device 1835 operates on the third virtual machine 1833. The third server 1840 includes third hardware 1841, a fourth virtual machine 1842, and first through nth virtual devices 1843 and 1844. In this example, the fourth virtual machine 1842 operates on the third hardware 1841, and the first through nth virtual devices, 1843 and 1844, operate on the fourth virtual machine 1842. As described above, the cloud computing service that provides a client with a virtual device may be referred to as a device as a service (DaaS).

The servers 1820, 1830 and 1840 described with reference to FIG. 19 are merely for purposes of example. It should be understood that the server farm 1800 may include any number of servers desired. Also, the servers may include any desired amount of virtual machines and virtual devices, and each virtual machine may have any desired amount of virtual devices operated thereon.

The management server 1700 may receive a cloud computing service request from the client 1610. In response to a cloud computing service request, management server 1700 may manage one or more of the servers 1820, 1830 and 1840 to operate a computing operation using at least one of the previously prepared virtual devices that are operated on one or more servers 1820, 1830 and 1840. For example, the management server 1700 may analyze service computing usage information of one or more clients including the client 1610 that uses the server farm 1800. The management server 1700 may predict demand for computing resources running in the server farm 1800. The demand may include one or more virtual devices and/or virtual machine. The management server 1700 may reserve computing resources for the servers 1820, 1830 and 1840 of the server farm 1800 based on the prediction result.

Cloud computing may be based on a “pay-per-use” model which charges a user based on the usage of the service. In some embodiments, the cost may be reduced if an equivalent service is provided using the minimum resources.

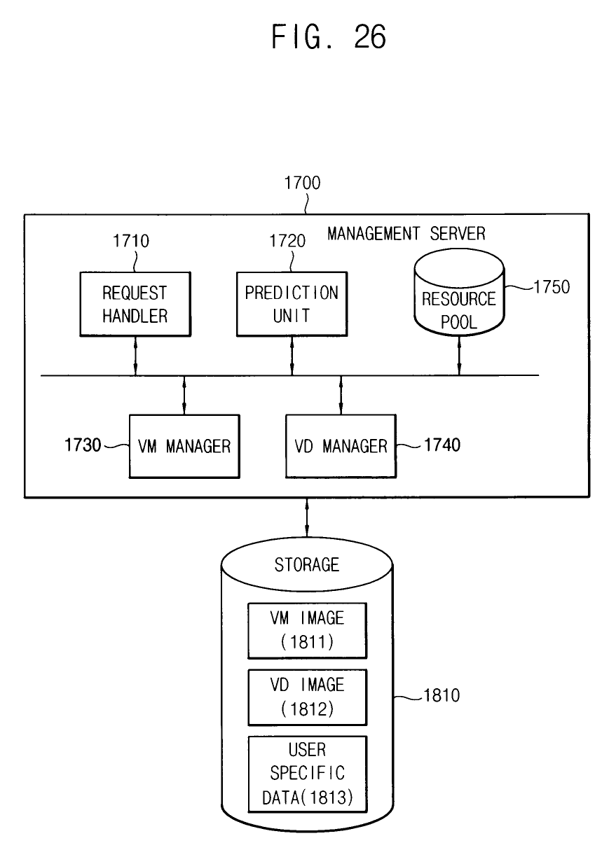

FIG. 26 is a block diagram illustrating an example of the management server in FIG. 25 according to some example embodiments.

Referring to FIG. 26, the management server 1700 includes a request handler 1710, a prediction unit 1720, a virtual machine (VM) manager 1730, a virtual device (VD) manager 1740 and a resource pool 1750.

In some embodiments, the request handler 1710 controls operations of the prediction unit 1720, the VM manager 1730, the VD manager 1740, and the resource pool 1750 to process a computing service request of the client 1610 and provide the requested computing service.

The request handler 1710 may determine whether a virtual device requested by the computing service request is available based on the resource pool 1750 that includes a management list for managing all virtual machines and virtual devices that are operated by the servers of a server farm, for example, the server farm 1800. According to a determination result, the request handler 1710 may perform an operation to provide the client 1610 with the virtual device requested.

The prediction unit 1720 predicts a type and number of virtual devices to be operated on one or more servers 1820, 1830 and 1840 of the server farm 1800. The prediction unit 1720 may analyze a history and a pattern of computing service requests by clients and computing service usage status for reserving virtual machines or virtual devices and predict a number of virtual machines and virtual devices that need to be reserved.

For example, the prediction unit 1720 may predict the minimum number of virtual machines that are required for securing the predicted type and/or the number of the virtual devices so as to increase the resource use efficiency. In another example, the prediction unit 1720 may predict the maximum number of virtual machines and virtual devices to guarantee available resources.

The request handler 1710 may control the VM manager 1730 and the VD manager 1740 to reserve the predicted type and/or number of virtual devices and a predetermined type and/or number of virtual machines before the request of the client is received. In some embodiments, upon receipt of the client's request, the request handler 1710 is capable of providing the reserved virtual devices without a delay occurring because the request handler already has the reserved virtual devices and the reserved virtual machines.

The VM manager 1730 may perform operations with respect to the virtual machines (e.g., loading of a virtual machine image, booting of a virtual machine image, shut-down of a virtual machine instance, etc.). A virtual machine instance refers to a virtual machine which is launched and which is available to a server. The VM manager 1730 may deploy (e.g., boot and load) at least one virtual machine on at least one server in preparation for the computing service request of the client. The VM manager 1730 may deploy the requested virtual machine according to the prediction result of the prediction unit 1720 on an available server of the server farm.

The VD manager 1740 may perform operations with respect to the virtual devices (e.g., loading of a virtual device image, booting of a virtual device image, shutting-down of a virtual device instance, etc.). A virtual device instance refers to a virtual device which is launched and which is available to a server. The VD manager 1740 may deploy at least one virtual device on a deployed virtual machine in preparation for the computing service request of the client. The VD manager 1740 may deploy the requested virtual device according to the prediction result of the prediction unit 1720 on an available server of the server farm 1800.

The resource pool 1750 may store and manage a management list for managing the virtual machines and virtual devices that are in operation on one or more servers of the server farm. The management list may include status information, performance information, user access information, computing service information, and the like, with respect to the virtual machines and the virtual devices.

The storage 1810 may store a virtual machine image 1811, a virtual device image 1812, and user specific data 1813 as files. Although the storage 1810 is provided in the server farm 1800 separately from the management server 1700 in FIG. 24, the storage 1810 may be provided externally of the server farm 1800 or may be configured to be integrated with the management server 1700. The storage 1810 may employ a plurality of the storage devices 200 of FIG. 2 and the storage 1810 may provide virtual storages to the management server 1700 or the one or more servers 1820, 1830 and 1840. In some embodiments, the storage 1810 may monitor the delete request to the virtual storage, and may erase a memory block of a nonvolatile memory device, including data at the physical addresses corresponding to data in the virtual storage using a virtual trim VTRIM command, in response to the delete request. In some embodiments, the storage 1810 may increase utilities of the virtual machines and the virtual devices by providing the virtual storages requested by the virtual machines and the virtual devices.

The virtual machine image 1811 is an image that is used when operating a virtual machine on a server. The virtual device image 1812 is an image that is used when operating a virtual device on a server. The user specific data 1813 refers to all data that is generated and modified by the client using a computing service, and in response to the client's request.

The request handler 1710 may store the user specific data 1813 that is generated and stored with respect to the computing service used by the client 1610 in the storage 1810. When the client 1610 issues a request for a previously used computing service, stored user specific data may be restored into a virtual device corresponding to the computing service request, and the restored virtual device may be provided to the client 1610. The virtual device may be provided where the user specific data 1813 is restored as the computing service, so that the client 1610 may be provided with the computing service using the virtual device in the same state where the user has previously used the virtual device.

As mention above, the storage device, including a plurality of nonvolatile memories, may enhance performance in virtualized environment by supporting virtualization, providing virtual storages, and supporting a virtual trim VTRIM command for erasing a memory block of an intervening nonvolatile memory, including the data at the physical addresses corresponding to data in the virtual storage according to some example embodiments. In some embodiments, the storage device may enhance performance without developing additional hardware by implementing the virtualization and the virtual trim command with firmware. In some embodiments, execution of the virtual trim command may not influence other operations because the virtual trim command may be executed while a corresponding nonvolatile memory is in an idle state.

Various example embodiments may be applicable to virtualized environment that support various operating systems.

The above-disclosed subject matter is to be considered illustrative and not restrictive, and the appended claims are intended to cover all such modifications, enhancements, and other embodiments, which fall within the true spirit and scope of the disclosed embodiments. Thus, the invention is to be construed by the broadest permissible interpretation of the following claims and their equivalents, and shall not be restricted or limited by the foregoing detailed description.

What is claimed is:

1. A method of operating a solid state drive including a controller and a nonvolatile memory, the method comprising:
creating a virtual memory drive with the nonvolatile memory, the virtual memory drive comprising multiple physical addresses;
storing a computer file in the virtual memory drive at a first set of locations corresponding to a first set of the multiple physical addresses;
associating the first set of the multiple physical addresses to a single logical address in a table;
moving the computer file in the virtual memory drive to a second set of locations corresponding to a second set of the multiple physical addresses; and
associating the second set of the multiple physical addresses to the single logical address in the table.

2. The method of claim 1, wherein the multiple physical addresses have a sequential order,
wherein storing the computer file in the virtual memory drive comprises storing the computer file in a first sequence of parts; and
wherein moving the computer file in the virtual memory drive comprises rearranging the first sequence of parts of the computer file to store the computer file in a second sequence of parts, the second sequence being different from the first sequence.

3. The method of claim 2, wherein the moving the computer file comprises moving only some of the parts of the computer file.

4. The method of claim 3, further comprising performing a garbage collection operation associated with those parts of the computer file which were moved.

5. The method of claim 4, further comprising generating an internal TRIM command by the controller for those parts of the computer file which were moved,
wherein the internal TRIM command is configured to cause the controller to erase the computer file during the garbage collection operation mode.

6. The method of claim 4, wherein the controller determines which parts of the computer file to move in order to free a block of NAND flash for an erase operation.

7. The method of claim 3, wherein the moving the computer file in the virtual drive memory comprises moving some of the parts of the computer file from a first block of NAND flash memory to a second block of NAND flash memory, and wherein the method further comprises:
erasing the first block of NAND flash memory.

8. The method of claim 8, further comprising:
rearranging the second sequence of parts of the computer file to store the computer file in a third sequence of parts, the third sequence being different from the second sequence.

9. The method of claim 9, wherein storing the computer file in a third sequence of parts comprises storing at least some of the parts of the computer file in the first block of NAND flash memory.

10. A storage device comprising:
a plurality of nonvolatile memories;
a controller configured to control the nonvolatile memories, configured to provide a virtual memory to an external host utilizing at least a first nonvolatile memory of the nonvolatile memories and configured to erase a first memory block of the first nonvolatile memory including first data stored in the virtual memory in response to a delete request of the first data stored in the virtual memory,
wherein the controller erases the first memory block of the first nonvolatile memory by generating an internal trim command in response to the delete request of the first data stored in the virtual memory.

11. The storage device of claim 10, wherein the controller is configured to generate a virtualization file table (VFT) to associate the first data in the virtual memory with a first set of physical addresses of memory locations storing the first data in the virtual memory.

12. The storage device of claim 11, wherein the VFT is stored in one of the nonvolatile memories.

13. The storage device of claim 11, wherein the VFT is stored in a volatile memory of the controller.

14. The storage device of claim 11, further comprising firmware including the controller configured by software, the firmware comprising:
a virtualization management module configured to generate the virtualization file table;
a flash address translator configured to convert logical addresses from the external host to physical addresses of the nonvolatile memories; and
a block management module configured to manage memory blocks of the nonvolatile memories,
wherein the block management module is configured to register a bad block address and to replace the bad block with a reserved block.

15. The storage device of claim 14, wherein the software of the firmware is stored in a ROM in communication with the controller.

16. The storage device of claim 11, wherein the controller is configured to erase the first memory block of the first nonvolatile memory in response to referencing the VFT, in response to the delete request of the first data in the virtual memory.

17. The storage device of claim 16, wherein the controller is configured to initiate the erase the first memory block of the first nonvolatile memory when the first nonvolatile memory is in an idle state.

18. The storage device of claim 16, wherein the controller is configured to delay initiation of the internal trim command until the first nonvolatile memory transitions to an idle state from a busy state.

19. The storage device of claim 16, wherein the controller is configured to initiate moving data of the first block of the first nonvolatile memory to a second memory block, and configured to erase the first memory block of the first nonvolatile memory after moving data in the first memory block to a second memory block, wherein all physical addresses of the second memory block not being associated with the virtual memory prior to initiating the moving of the data in the first memory block to the second memory block are erased.

20. A method of operating a solid state drive including a controller and a nonvolatile memory, the method comprising:
creating a virtual memory drive with the nonvolatile memory, the virtual memory drive having multiple logical addresses corresponding to multiple physical addresses;
storing a computer file in the virtual memory drive at a first set of the multiple physical addresses;
moving the computer file in the virtual memory drive to a second set of the multiple physical addresses; and
performing a garbage collection operation of the nonvolatile memory associated with at least a portion of the first set of multiple physical addresses corresponding to those parts of the computer file which were moved,
wherein storing the computer file in the virtual memory drive comprises storing the computer file in a first sequence of parts; and
generating an internal TRIM command by the controller for the nonvolatile memory associated with at least a portion of the first set of multiple physical addresses corresponding to those parts of the computer file which were moved;
wherein moving the computer file in the virtual memory drive comprises rearranging the first sequence of parts of the computer file to store the computer file in a second sequence of parts, the second sequence being different from the first sequence.
